(19) United States
(12) Patent Application Publication
(10) Pub. No.: US 2022/0002139 A1
(43) Pub. Date: Jan. 6, 2022

(54) SYSTEM AND METHOD FOR DYNAMIC SELECTION OF FLUIDS

(71) Applicant: Mixxy Products, LLC., Belvedere, CA (US)

(72) Inventors: Drew Dawson, Larkspur, CA (US); Nicolas Belgum, Tiburon, CA (US); Benjamin Martin, San Francisco, CA (US); Michael Chad Makay, San Francisco, CA (US); Yale Franklin Shaw, San Francisco, CA (US); Ariel David Turgel, San Francisco, CA (US)

(21) Appl. No.: 17/367,271

(22) Filed: Jul. 2, 2021

Related U.S. Application Data
(60) Provisional application No. 63/047,595, filed on Jul. 2, 2020.

(51) Int. Cl. B67D 3/00; G05D 11/03

(52) U.S. Cl. CPC B67D 3/0016; B67D 3/0067; G05D 11/03

(57) ABSTRACT

Aspects of the disclosure provide methods, apparatuses, and systems for providing variable strength mixtures of fluids. In an aspect of the disclosure, a fluid combining device allows for the relative volume of a first liquid to be varied with respect to a total volume of fluid being delivered to a user (such as a combination of two or more liquids), which in turn changes the fluid ratios.

### PRIORITY

The instant application claims priority to U.S. Provisional Patent Application 63/047,595, filed Jul. 2, 2020, titled, Fluid Combining Valve, which is incorporated in its entirety herein.

### BACKGROUND

Hydration packs and bladders have gained wide acceptance for a number of applications. Endurance athletes, military personnel, backpackers, cyclists, and other sports enthusiasts routinely use refillable bladders with a tube attached for easy drinking and convenient storage.

Many endurance athletes use hydration packs that carry water mixed with electrolytes (salts and other nutrients) to maintain not only hydration, but to reduce muscle fatigue. Electrolytic solutions allow for longer periods of exertion during competitions and/or long events where continuous and/or semi-continuous performance is desired. During an event, athletes may wish to increase or decrease the amount of electrolytes being consumed, based on event duration, upcoming challenges, etc.

Current hydration systems provide a single source of hydration/electrolytes and changing the amount of electrolytes per unit volume of fluid is difficult. Either the user must add more water to the bladder to reduce the ratio of electrolytes to water, or add more electrolytes to increase the ratio of electrolytes to water. In either case, current hydration system designs are not readily accessible to allow these additions of water and/or electrolytes to create variable strength electrolyte solutions.

### SUMMARY

Aspects of the present disclosure generally relate to valves, and more particularly to a fluid combining valve with a variable concentration control.

Aspects of the disclosure provide methods, apparatuses, and systems for providing variable strength mixed solutions. In an aspect of the disclosure, a combining and/or mixing valve allows for the relative volume of a first solution to be varied with respect to a second solution and/or to a total volume of fluid being delivered to a user. Exemplary embodiments may therefore be used to create dynamically controlled compositions of one, two, or more fluids to be delivered to a user.

This has outlined, rather broadly, the features and technical advantages of the present disclosure in order that the detailed description that follows may be better understood. Additional features and advantages of the disclosure will be described herein. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further purposes and advantages, will be better understood from the following description when considered in connection with the accompanying figures. It is to be expressly understood, however, that each of the figures is provided for the purposes of illustration and description only and is not intended as a definition of the limits of the present disclosure.

### DRAWINGS

For a more complete understanding of the present disclosure, reference is now made to the following description taken in conjunction with the accompanying drawings.

FIG. 1 illustrates an embodiment of a fluid delivery device in accordance with an aspect of the present disclosure;

FIG. 2A illustrates an open bottom view of a fluid mixing device in accordance with an aspect of the present disclosure;

FIG. 2B illustrates an open top view of a fluid mixing device in accordance with an aspect of the present disclosure;

FIG. 2C illustrates an actuator in accordance with an aspect of the present disclosure;

FIG. 2D illustrates a housing in accordance with an aspect of the present disclosure;

FIG. 3A illustrates a perspective top view of a fluid mixing device having a controller in accordance with an aspect of the present disclosure;

FIG. 3B illustrates a side view of a fluid mixing device having a controller in accordance with an aspect of the present disclosure;

FIG. 3C illustrates a top view of a fluid mixing device having a controller in accordance with an aspect of the present disclosure;

FIG. 3D illustrates a rear view of a fluid mixing device having a controller in accordance with an aspect of the present disclosure;

FIG. 3E illustrates an exploded component view of a remote selector in accordance with an aspect of the present disclosure;

FIGS. 3F and 3G illustrate component views of the remote selector of FIG. 3E in accordance with aspects of the present disclosure;

FIGS. 4A and 4B illustrate partial component views of a fluid combining device in accordance with an aspect of the present disclosure;

FIGS. 5A and 5B illustrate a fluid containing device in accordance with an aspect of the present disclosure;

FIG. 5C illustrates a portion of a fluid containing device in accordance with an aspect of the present disclosure;

FIG. 6A illustrates a perspective view of a coupler in accordance with an aspect of the present disclosure;

FIGS. 6B and 6C illustrate partial component views of the coupler of FIG. 6A in accordance with an aspect of the present disclosure;

FIGS. 7A, 7B, and 7C illustrates a partial view of a fluid containing device in accordance with an aspect of the present disclosure; and

FIG. 8A illustrates a perspective view of a holder in accordance with an aspect of the present disclosure; and

FIG. 8B illustrates a partial component view of the holder of FIG. 8A in accordance with an aspect of the present disclosure.

FIGS. 9 through 35 illustrate exemplary components (including, without limitation, fluid combining devices, fluid control mechanism, selectors, indicators, fluid containing devices, user delivery interface, and holders) according to embodiments described herein that may be combined in any combination to create a fluid delivery device in accordance with aspects of the present disclosure.

### DETAILED DESCRIPTION

The detailed description set forth herein, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

The present disclosure describes methods, apparatuses, and systems for providing variable strength mixed solutions. In an aspect of the disclosure, a mixing valve allows for the relative volume of a first liquid to be varied with respect to a relative volume of a second liquid and/or to a total volume of fluid being delivered to a user. The variable composition may permit a user to dynamically control a solution composition from its constituent components.

Although embodiments of the invention may be described and illustrated herein in terms of a hydration system and specifically for the combination of a solution of water and an electrolyte that may be dynamically mixed, it should be understood that embodiments of this invention are not so limited. Exemplary embodiments may be used in the delivery of one or more fluids to a user. For example, the systems and methods described herein may be used to combine social drinks, flavored drinks, other additives, such as sugar, electrolytes, caffeine, alcohol, flavoring, etc. In addition, the use and environment of the applications of embodiments described herein are similarly not restricted. Exemplary embodiments may be used to contain and delivery fluids through any combination of the features described herein, for any purpose, and not simply hydration and/or for athletic or sport applications. Exemplary embodiments may also include health and wellness applications to provide, for example, water in combination to nutrients to a user a desired times or in response to a user's feelings, conditions, or monitored condition. Exemplary embodiments may be used in social applications, such as in delivery different fluids to a user for individual use, and/or for social gatherings in which embodiments of the selection of a desired mixture permits different guests to customize their beverage while the host is permitting to simply fill two or more compartments of the fluid containing device. All such variations are understood to be within the scope of the instant disclosure.

Exemplary embodiments described herein may include any combination of the features shown and described herein. The illustrated embodiments are exemplary only and represent a illustrative combination of features. Any feature or component shown or described herein may be included in any combination. For example, components may be recombined, added, subtracted, integrated, separated, duplicated, or otherwise combined to create a fluid container, fluid combining device, fluid delivery device, and/or used for methods of containing, delivering, and/or combining fluids.

Exemplary embodiments described herein may comprise a fluid delivery device and systems and methods for dynamically mixing fluid concentrations for delivery to a user. Exemplary embodiments of the fluid delivery device and methods of delivering fluids may include one or more of any combination of: fluid containing device(s), fluid combining device(s), user delivery interface(s), fluid connector(s), valve(s), holder(s), controller(s), selector(s), fluid control mechanism(s), fluid input(s), fluid output(s), actuator(s), limiter, indicator, etc.

Exemplary embodiments of the fluid delivery device described herein may include a fluid combining device. The fluid combining device may be configured to dynamically control the amounts of two or more fluids for delivery through the fluid delivery device. The fluid combining device may include two or more fluid inputs. For example, the fluid combining device may include a first fluid input for receiving a first fluid and a second fluid input for receiving a second fluid. The fluid combining device may include one or more fluid control mechanisms for controlling an amount of fluid from the first fluid input, the second fluid input, or both the first and second fluid input. By controlling an amount of fluid from one or more of the fluid inputs, a concentration of a mixture of the fluids at a fluid output can be dynamically selected.

Exemplary embodiments of the fluid delivery device comprising a fluid combining device may include a selector. The selector as shown and described herein may include one or more user input device in association with and/or for manipulating one or more valves for controlling an amount of fluid from the one or more fluid inputs. Exemplary embodiments of a selector may include any combination of a rotary knob, switch, slider, dial, button, lever, screw, or any other configuration shown and described herein. Exemplary embodiments of the selector may interface with and/or be used to select a position of a fluid control mechanism. Fluid control mechanisms described herein may include any combination of valves, such as pinch valve, ball valve, butterfly valve, peristaltic valve, check valve, gate valve, plug valve, iris valve, or any other valve or configuration as shown and described herein. Exemplary fluid control mechanisms described herein include valves configured to change a fluid flow through the fluid control mechanism by changing a cross sectional area of the fluid flow passage. The cross sectional area may be changed by externally compressing a conduit defining the fluid flow passage, and/or internally obstructing the fluid flow passage of the fluid flow conduit.

Exemplary embodiments of the fluid delivery device comprises an actuator. The actuator may be configured to provide predetermined positions of the selector and/or other fluid control mechanisms described herein to control and provide preselected mixture combinations of fluids for delivery from the fluid delivery system. For example, the actuator may be set to permit the combination of fluids such as through the selector to provide 0% of one fluid (so that all of one fluid is provided), 25% of one fluid compared to the total fluid, 50% of one fluid to the total fluid, or 100% of one fluid compared to the total fluid (all of the one fluid). The selector may also provide continuous selection of one fluid compared to the total fluid from the fluid delivery system. Exemplary embodiments of the selector may also include a two position selector in which the fluid flow is turned off and/or on, or providing a selection of one fluid or the other fluid without the mixture of the fluids.

Exemplary embodiments of the fluid combining device, the selector (including the remote selector), or other components described herein may include a biasing element. The biasing element may be used to position the selector to a predetermined selection. The biasing element may be used in combination with the actuator, selector, fluid control mechanisms, or other components of the system in order to control the selection of a fluid mixture from the fluid containing device. For example, the biasing element may predispose the selector to a first configuration (such as all the way open for the selection of one fluid). A user may apply force on the selector in order to rotate the selector and reposition the fluid control mechanisms and select a combination of fluids from the fluid containing device. The actuator may limit the position of the selector to a predetermined option corresponding with a specific mixture combination. The user may release the selector (such as by controller a remote selector), and the biasing element may then move the selector back toward the biased, original position, and/or the actuator may be configured to retain the selector in the desired selected position until the user engages the selector again.

Exemplary embodiments of the fluid delivery device described herein may include a user delivery interface. Exemplary embodiments of the user delivery interface may be configured to deliver the combined fluid from the fluid combining device to the user. The user delivery interface may be sized and shaped for delivery of fluid to the user. The size and shape may be dependent upon the container and/or application of the fluid delivery device according to embodiments described herein. For example, if exemplary embodiments of the fluid delivery system are configured as a water bottle, the user delivery interface may include a spout, straw, bite valve, or similar interface, while if the exemplary embodiments of the fluid deliver system are configured as a back pack water bag, the user delivery interface may not include a spout or a straw, but instead utilize the bite valve, hose, or similar interface, while if the exemplary embodiments of the fluid delivery system are configured as a cooler, the user delivery interface may include a spigot, nozzle, or lip.

Exemplary embodiments of the fluid delivery device described herein may include a fluid containing device. The fluid containing device may include two or more compartments for holding the fluid for input to the fluid combining device and/or for delivery to a user through the fluid delivery device. In an exemplary embodiment, the fluid containing device comprises a first compartment configured with a first interior cavity for retaining a first fluid and a second compartment configured with a second interior cavity for retaining a second fluid. The first compartment and second compartment may be separated to reduce or prevent mixing of the first fluid from the second fluid except through the fluid combining device described herein.

Exemplary embodiments of the fluid containing device described herein may include different configurations. For example, the first compartment and the second compartment may be separate fluid containers and/or may be integrated into the same container with separate sections therein. The fluid container may also be in different utility forms, such as bags, bottle, cooler, replaceable pods, disposable packages, or any other fluid delivery container. Exemplary embodiments of the fluid containing device are mobile. The fluid containing device may be small enough to be carried by a user.

Exemplary embodiments of the fluid containing device may include couplers. Exemplary couplers may be configured to achieve any combination of functions, such as, without limitation: to couple components of the fluid containing device, such as separate fluid compartments tougher; to seal and/or close the fluid compartments; to retain or attach the fluid containing device to another component of the system, such as holder; and/or support the fluid containing device and provide a handle thereto.

Exemplary embodiments of the fluid containing device may include a sealing device. The sealing device may operate alone or in combination with other system components, such as, for example, the coupler to close an opening(s) of the fluid compartment(s) and/or reduce leakage therefrom. The sealing device may include structure that is part of the fluid containing device that is configured to cover and close the opening. The sealing device may then define a structure for attachment to and engagement with the coupler. For example, the coupler may include a channel, and the sealing device may be configured in a closed position as an insert to the channel. The sealing device may therefore have an outer profile configured to approximate an interior profile of a channel such that the channel may retain the sealing device in a closed position.

Exemplary embodiments of the fluid delivery device may include various fluid connectors. The fluid connectors may be used to couple the fluid containing device, the fluid combining device, the inputs, the outputs, and other components described herein. In an exemplary embodiment, the fluid connectors may be tubes. Exemplary embodiments include a first fluid connector between the first compartment and the first fluid input of the fluid combining device, a second fluid connector between the second compartment and the second fluid input of the fluid combining device, and a third fluid connector from the fluid output of the fluid combining device and the user interface.

Exemplary embodiments of the fluid delivery device described herein may include fluid control mechanisms. These fluid control mechanisms may include components including combinations of selector(s), controller(s), restrictor(s), valve(s), or other components described herein for controlling, effecting, or otherwise influence the flow of fluid through the system. For example, exemplary embodiments may include flow valves that permit the variable selection of fluid through the system. Exemplary embodiments may include selectors and valves as described with respect to the fluid combining device. Exemplary embodiments may include flow valves that stop flow from the system. Exemplary embodiments may include closing valves for the selective output of fluid from the fluid delivery device. Such closing valves may be used to reduce unintentional fluid flow from the fluid delivery device when the device is not in use. Exemplary embodiments may include fluid control mechanisms that dictate and/or limit flow direction in one or more components of the system, such as between component parts, within flow connectors, into components of the system, out of components of the system, and combinations thereof. Exemplary embodiments of fluid control mechanisms may include check valves.

Exemplary embodiments of the fluid control mechanisms may include selectors, valves, controllers, and combinations thereof for configuring the system according to embodiments described herein and/or in permitting the dynamic control of a solution composition from its constituent components supplied through the fluid delivery device.

Exemplary embodiments of a fluid control mechanism comprises a remote selector for the fluid combining device. The remote selector may provide a user control input for dynamic control of a solution composition from its constituent components supplied through the fluid delivery device by permitting a user to provide input to the system and position a desired solution composition through the fluid combining device. The remote selector may be positioned away from the fluid combining device and communicate with the fluid combining device in order to make the user selection through the remote selector and control the fluid combining device fluid control mechanisms.

In an exemplary embodiment, the remote selector may comprise a mechanical system that physically links the remote selector to the fluid control mechanism(s) of the fluid combining device to permit a user to adjust one or more flow rates and/or the resulting concentration of the solution composition from the fluid combining device.

Exemplary embodiments of the remote selector may be physically unattached from embodiments of the rest of the fluid delivery system. For example, the remote selector may be an electronic selector that wirelessly communicates with a fluid control mechanism of the fluid combining device. The remote selector may be through any electronic interface, such as a smart device, mobile phone, tablet, laptop, computer, smart watch, health monitoring device (such as a pedometer), electronic activity device (such as speedometer, power monitor, etc. used in cycling or other athletic endeavor), electronic controller. The remote selector may include a user input device, such as any of the user engagement devices of the fluid control mechanisms and/or selectors described herein (switches, nobs, buttons, etc.), or display system (such as a touch screen) that permits the user to select a desired ratio of a first fluid relative to a second fluid or to the fluid output to select the fluid control mechanism of the fluid combining device to correspond to the desired ratio. Exemplary embodiments of the fluid combining device may therefore include electronics for receiving a wireless control signal from the remote selector and/or in adjusting the fluid control mechanism to correspond to the received control signal.

Exemplary embodiments described herein may include processors, memory, and electronic components to automate one or more portions of the system described herein. For example, the system may receive health information from the user. The health information may include, or example, an activity level, hydration level, heart rate, perspiration level, etc. The system may be configured to determine a desired ratio of a fluid to the total delivered fluid and/or the desired ratio of one fluid to another fluid (or more fluids) in order to control the selector and/or fluid control mechanisms described herein and set the fluid combining device accordingly. The system may therefore automate all or a portion of the selection of the fluid combining device. The system may be configured to set the ratio, and allow the user to thereafter alter the setting for a desired delivery of fluid from the fluid delivery system. The system may be configured to provide an indication of a recommended ratio, that the user can accept, change, or decline in setting the fluid combining device.

Exemplary embodiments of the fluid delivery device may include an indicator. The indicator may provide a visual indicator to the user of the selection for the relative constituent combination of the output from the fluid delivery device. For example, a visual indicator may include, for example, a numeric indicator of a percentage of one fluid as compared to a total, a color indicator in which a color is associate with one fluid and a separate color is associated with another fluid and a length of the color or proportion of the color to the total indicates the relative percentage, or a color is associated with different percentages, etc. The indicator may also be tactile so that a user is provided an indication of the selection through touch. The tactile indicator, may be for example, vibration, internal resistance (such as, for example, a progressive resistance in position and/or in clicking into respective positions on a dial), external textures on the selector, or the relative position of the selector to the indicator or other portions of the system.

Exemplary embodiments described herein include a system for the fluid delivery device including a holder. In an exemplary embodiment, the holder may be an exterior structure configured to hold one or more components, such as the fluid containing device(s), fluid combining devices, fluid connectors, fluid control mechanisms, valves, etc. The exterior structure may comprising insulation to keep the fluid at a desired temperature. The exterior structure may include a holding structure, such as pockets. The exterior structure may be configured as a holder, such as a bag, backpack, etc. The exterior structure may include straps, connectors, fasteners, handles, etc.

Exemplary embodiments described herein are described for the containment, combining, and/or delivery of two fluids. However, the disclosure is not limited to only two fluids. Exemplary embodiments may include two or more fluids for combining and delivering to a user. Exemplary embodiments may include fluid connectors from additional fluid sources and/or containers and/or compartments. The system may therefore include additional containers, compartments, connectors, valves, selectors, controllers, etc. The selection may be through an integration of the fluid combining device configured to handle additional fluids or through the duplication of the selector between two original fluids and then with a third original fluid and a combined fluid from the two original fluids, such as by using two fluid combining device, with each fluid combining device have two fluid inputs and a fluid output, where one fluid combining device has an output as one of the inputs to a second fluid combining device.

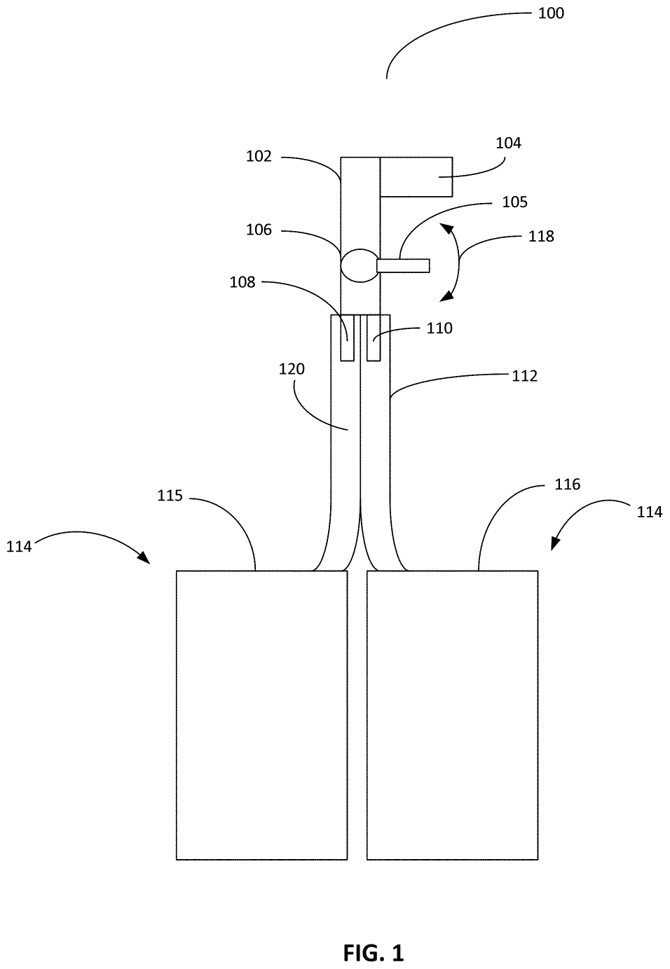

FIG. 1 illustrates an embodiment of a hydration system in accordance with an aspect of the present disclosure.

Exemplary embodiments of a fluid delivery system 100 includes a user delivery interface 102, fluid combining device 106, and fluid containing device 114. Exemplary embodiments of the fluid combining device may include a selector 105. Exemplary embodiments of the user delivery interface 102 may include an outlet 104. The output 104 may include a separate closing valve, such as, for example, a bite valve and/or other closing valve as described herein. Exemplary embodiments of the fluid containing device 114 may comprise fluid compartments 115, 116. Exemplary embodiments described herein may also include connectors 112, 120.

Exemplary embodiments of the user delivery interface 102 may provide an on-off control of fluid flow from fluid inputs 108, 110 to outlet 104. In an exemplary configuration, each of the fluid compartments 115, 116 may be in fluid communication with separate and respective fluid inputs 108, 110 of the fluid combining device and then in fluid communication with the user delivery interface 102. For example, the first fluid compartment 115 may be in fluid communication through first fluid connector 120 with first fluid input 108 of fluid combining device 106 to the output of the fluid combining device 106 to user delivery interface 102 to the system outlet 104, and the second fluid compartment 116 may be in fluid communication through second fluid connector 112 with second fluid input 110 of fluid combining device 106 to the output of the fluid combining device 106 to user delivery interface 102 to the system outlet 104. Thus, the fluid flow paths may be separate and distinct and out of fluid communication upstream of the fluid combining device 106

In an exemplary embodiment, the fluid combining device 106 may include one or more fluid control mechanisms to provide a variable ratio of fluids flowing from valve inlets 108 and 110 to outlet valve 104. With a single outlet 104, and two inlets 108 and 110, a fluid control mechanism within fluid combining device 106 may be considered as a “three-way” valve. However, additional numbers of inlets and/or outlets to fluid combining device 106 are possible without departing from the scope of the present disclosure. Fluid combining device 106 may have one or more fluid control devices such as a pinch valve, but may also be a ball valve, gate valve, check valve, butterfly valve, and/or any other type of valve without departing from the scope of the present disclosure.

Outlet 104 provides an access point to fluids contained within fluid containing devices 114 having fluid compartments 115, 116. Outlet 104 may be merely an opening that is in fluid communication with fluid combining device 106, may be fluid control device (such as tubing) that is coupled to fluid combining device 106, and/or may have additional components that may provide further control of the fluid flow through outlet 104. For example, and not by way of limitation, outlet 104 may include a membrane having a slit through the membrane, which is more commonly known as a “bite valve.” A bite valve operates by pressing on a circumference of outlet 104, which opens the slit and allows fluid to flow through outlet 104. The pressure to open a bite valve is usually provided by a user biting on outlet 104, and when the bite pressure is released, the slit closes and restricts/prevents the flow of fluid through outlet 104. Other types of fluid control mechanisms may be possible in outlet 104 without departing from the scope of the present disclosure. For example, other selective closing valves may be provided.

Exemplary embodiments of the fluid combining device 106 may include a selector 105 configured to permit a user to control the flow of fluid from valve inlets 108 and 110 through user delivery interface 102. For example, and not by way of limitation, selector 105 may be coupled to the ball of a ball valve, such that the hole through the ball valve is rotated when selector 105 is rotated in direction 118. When rotated, selector 106 may control the amount of flow permitted through one or more of valve inlets 108 and 110. Further, when rotated, selector 105 may control the ability for fluid to flow our of the fluid combining device 106, and may act as a stopper of fluid out of the fluid delivery system 100 through outlet 104.

Fluid combining device 106 fluid inputs 108, 110 are coupled to fluid connectors 112, 120 such that fluids stored in fluid compartments 115, 116 may be delivered from fluid compartments 115 and/or 116 to outlet 104. Fluid connector 120, 112 may be tubing. In an exemplary embodiment, the fluid connector 120, 112 may be a single tube having a divider, or may be a plurality of tubes, such that fluid input 108 is coupled to fluid compartment 115, and fluid input 110 is coupled to fluid compartment 116, without any intermingling of fluids from compartments 114 and 116 prior to those fluids entering fluid combining device 106. Although shown as approximately the same volume in FIG. 1, compartments 115 and 116 may have different volume capacities without departing from the scope of the present disclosure. For example, a first compartment 115 may be smaller than a second compartment 116 or may be approximately the same size. The smaller compartment may be approximately ¼. ⅓, ½, or other portion of the larger compartment.

One or more of compartments 115 and/or 116 may be a “disposable” or “recyclable” container, in that one or more of compartments 115 and/or 116 may be removable from system 100. Further, the disposable compartment 115 and/or 116 may be a pre-filled reservoir, in that a pre-mixed fluid, e.g., concentrated electrolyte solution, or other additive described herein, may be coupled to system 100, and a user may add only water (or other fluid) to the remaining reservoir 115 and/or 116. The removable/disposable reservoir may allow for system 100 to remain cleaner, as residue from electrolyte solutions may provide for bacterial growth within system 100.

In operation, a user may place a first fluid in first fluid compartment 115 and a second fluid in second fluid compartment 116. For example, and not by way of limitation, first fluid may be water, and second fluid may be a concentrated electrolyte solution. When the user desires hydration and/or electrolytes, fluid combining device 106 may be placed in a desired mixing position through selector 105 position such that first fluid from the first compartment 115 (water) may be delivered without electrolytes, second fluid from the second fluid compartment 116 (electrolytes) may be delivered without additional water, and/or a mixture of first fluid and second fluid may be delivered to the user. Based on the position of a fluid control mechanism in fluid combining device 106, and/or the direction 118 that selector 105 is moved, one or more of the fluids in fluid compartment 115 and/or 116 may be delivered as desired. Other fluids can be placed in compartments 115, 116, e.g., lemonade in reservoir 114 and iced tea in reservoir 116, such that the sweetness and/or concentration of lemonade with respect to the iced tea can be controlled. Other fluids can also be used without departing from the scope of the present disclosure. Exemplary embodiments may be used to incorporate additives into a fluid mixture according to the needs and/or desires of the user.

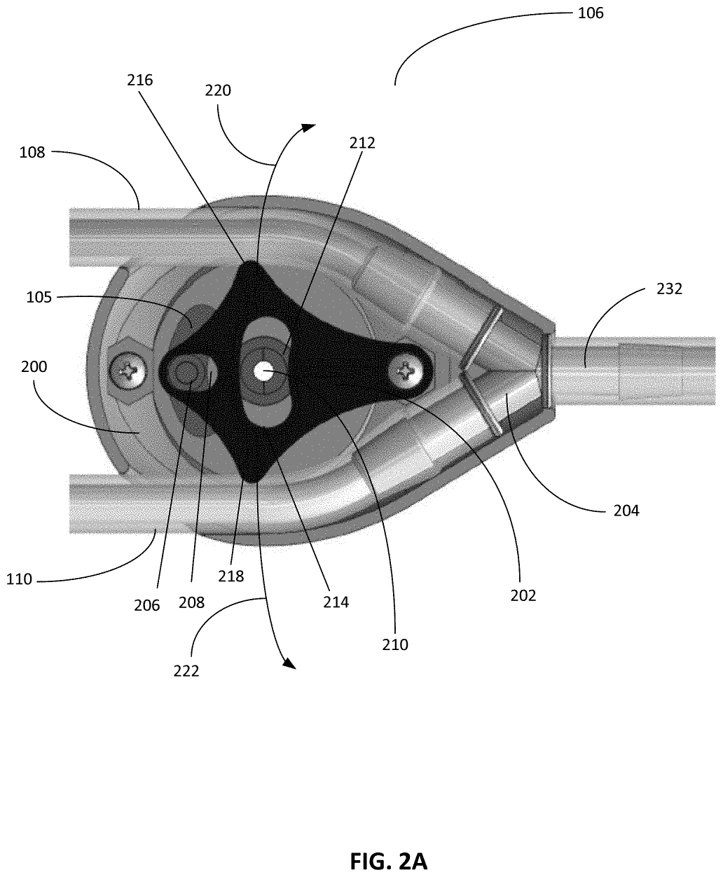

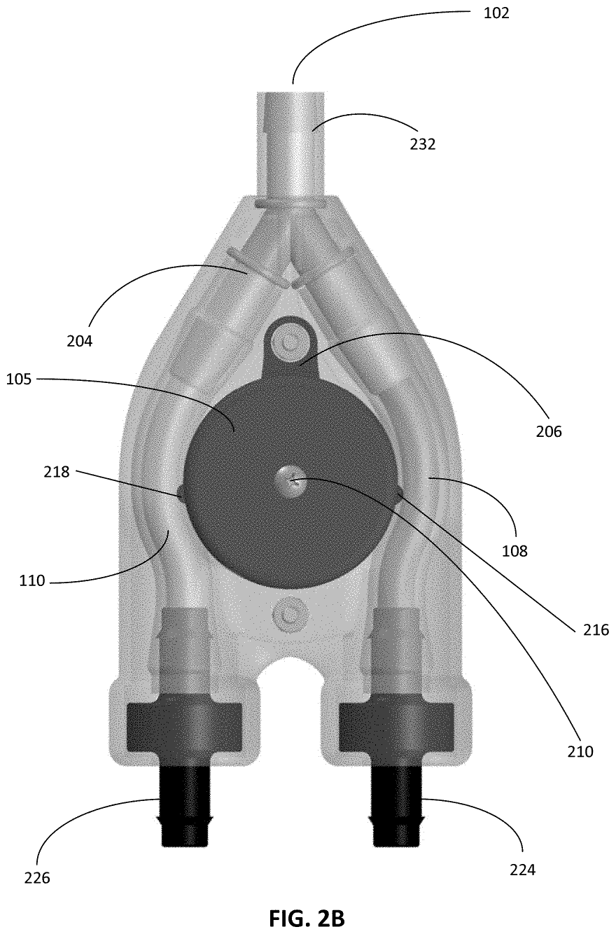

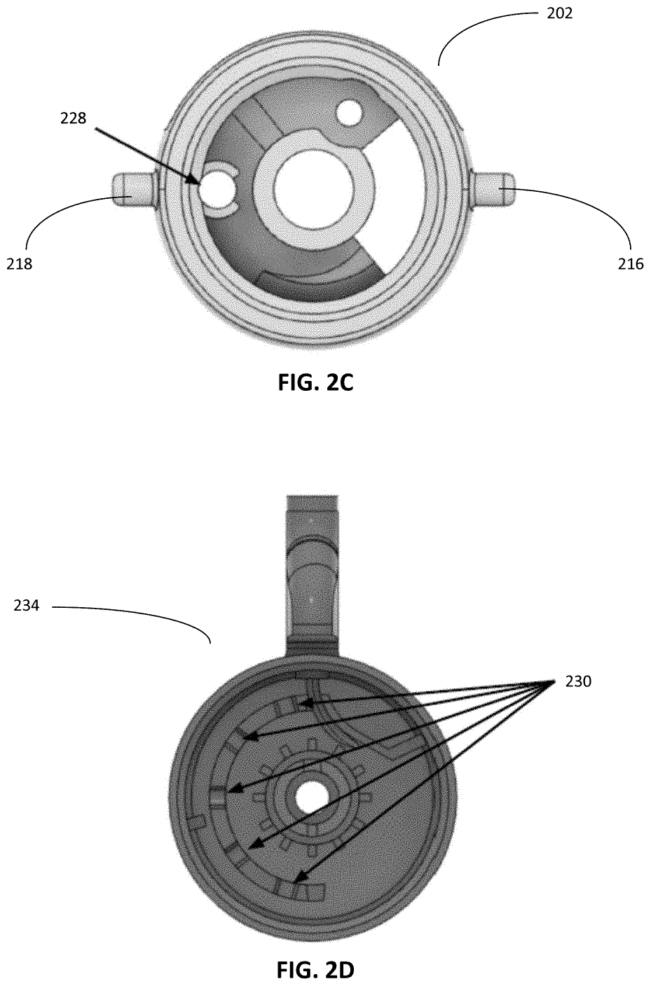

FIGS. 2A-2C illustrate an exemplary fluid combining device 106 according to embodiments described herein. The fluid combining device 106 of this embodiment is exemplary only. Exemplary embodiments of the fluid combining device comprises fluid control mechanisms. The fluid control mechanisms may include pinch valves that may be configured to limit a comparative fluid flow through one or more passages of the valve in comparison to another fluid flow of another passage. The fluid control mechanism may limit a comparative flow by controlling or reducing a cross sectional area of the fluid flow passages. The cross sectional area of the fluid flow passage may be reduced or increased by applying external pressure and squeezing the body (tube) creating the passage. Other configurations of increasing and/or reducing the cross sectional area are also contemplated herein, such as other configurations of constriction. For example, an reducing diameter iris may be used. Other flow valves may also be used as described herein.

FIG. 2A illustrates an open bottom view of a fluid combining device according to embodiments described herein.

The fluid combining device 106 may include one or more fluid control mechanisms for controlling an amount of fluid from the first fluid input, the second fluid input, or both the first and second fluid input. By controlling an amount of fluid from one or more of the fluid inputs, a concentration of a mixture of the fluids at a fluid output can be dynamically selected. As illustrated, the fluid combining device 106 can have a first fluid input 108, a second fluid input 110, and a fluid output 232. Although two fluid inputs are illustrated, more than two fluid inputs may be configured into the device. Similarly, more than one fluid output may be configured into the device.

Exemplary embodiments of the fluid combining device 106 may include a housing 200. In an aspect of the present disclosure, housing 200 holds various components of fluid combining device 106, e.g., selector 105, actuator 202, and wye 204. Housing 200 is shown in open or “cutaway” view, such that internal components of fluid combining device 102 can be illustrated for ease of understanding. Housing 200 may be enclosed and may cover some and/or all of the components of fluid combining device 106 without departing from the scope of the present disclosure.

In an aspect of the present disclosure, selector 105 may be coupled to actuator 202 via pin 206 that couples to opening 208 in actuator 202. Selector 106 may rotate about axis 210, where pin 212 of selector 105 couples to opening 214 of actuator 202.

As selector 105 is rotated, pin 206 moves in a radius around axis 210 and pin 212 rotates about axis 210. As the rotation of control 106 continues, one of pinch points 216, 218 begins to squeeze incoming tubing 108 and/or 110 to reduce the flow in one of the incoming tubes 108 and/or 110. In an aspect of the present disclosure, reducing the flow rate in one of the incoming tubes, e.g. tube 108, with respect to the other incoming tube, e.g., tube 110, changes the ratio of the fluids as these fluids are mixed in wye 204 and exit fluid combining device 106 at outlet 232.

With reference to FIG. 2A, when selector 105 is rotated in direction 220 (clockwise as shown in FIG. 2A), pin 206 moves in a clockwise direction within opening 208, while pin 212 rotates around axis 208 within opening 214. Pin 206 will, at some point in the rotation, reach the end of opening 208 and move actuator 202 in a clockwise manner, which brings pinch point 216 toward tubing 108. As pinch point 216 contacts tubing 108, the cross-sectional area of tubing 108 may be reduced, which may reduce the flow rate of fluid flowing in tubing 108.

However, when selector 105 is rotated in direction 220, pinch point 218 moves away from tubing 110, which leaves the flow rate of fluid in tubing 110 undisturbed. As such, the ratio of fluid flowing in tubing 108 with respect to the fluid flowing in tubing 110 has been changed, with the amount of fluid flowing in tubing 108 being reduced with respect to the amount of fluid flowing in tubing 110.

As selector 105 is rotated further in direction 220, pinch point 216 will continue to increase the amount of pressure on tubing 108, and further reducing the amount of fluid flowing in tubing 108 with respect to the fluid flowing in tubing 110. At some point in the rotation of control 106, pinch point 216 may completely inhibit any fluid flowing in tubing 108, and the only fluid that will flow through wye 204 and outlet 232 is fluid from tubing 110.

When selector 105 is rotated in direction 222 (counter-clockwise as shown in FIG. 2A), pin 206 moves in a counter-clockwise direction within opening 208, while pin 212 rotates around axis 208 within opening 214. Pin 206 will, at some point in the rotation, reach the end of opening 208 and move actuator 202 in a counter-clockwise manner, which brings pinch point 218 toward tubing 110. As pinch point 218 contacts tubing 110, the cross-sectional area of tubing 110 may be reduced, which may reduce the flow rate of fluid flowing in tubing 110.

However, when selector 105 is rotated in direction 222, pinch point 216 moves away from tubing 108, which leaves the flow rate of fluid in tubing 108 undisturbed. As such, the ratio of fluid flowing in tubing 110 with respect to the fluid flowing in tubing 108 has been changed, with the amount of fluid flowing in tubing 110 being reduced with respect to the amount of fluid flowing in tubing 108.

As selector 105 is rotated further in direction 222, pinch point 218 will continue to increase the amount of pressure on tubing 110, and further reducing the amount of fluid flowing in tubing 110 with respect to the fluid flowing in tubing 108. At some point in the rotation of control 106, pinch point 218 may completely inhibit any fluid flowing in tubing 110, and the only fluid that will flow through wye 204 and outlet 104 is fluid from tubing 108.

FIG. 2B illustrates an open top view of a valve in accordance with an aspect of the present disclosure.

Selector 105 is shown from a top perspective in FIG. 2B, and when FIGS. 2A and 2B are viewed together, it is seen that selector 105 rotates about axis 210. Pin 206 (as seen in FIG. 2A) then moves as described.

Also shown in FIG. 2B are additional fluid flow mechanisms. Additional fluid flow mechanisms may be incorporated into the fluid delivery device in order to control a flow direction within the system. For example, valve 224 may be coupled to tubing 108 and valve 226 coupled to tubing 110. Valves 224 and 226 may be check valves that may allow for a unidirectional flow from fluid compartment 115, 116 through user delivery interface 102 and out of outlet 104. Valves 224 and 226 may be other types of valves as desired. Valves 224 and 226 are in fluid communication with fluid compartments 115 and 116 and the wye 204 through fluid connectors. Exemplary embodiments include tubing 108 and 110 between wye 204 and valves 224 and 226. Valves 224 and 226 may also reduce and/or eliminate mingling of the fluid in reservoir 114 with the fluid in reservoir 116.

The opening (also known as “cracking”) pressure of valves 224 and 226 may be small, such that suction from outlet 232 (e.g., via a tube connected to outlet of the fluid combining device 106) is able to open valves 224 and 226 and allow fluid to flow from fluid compartments 115 and/or 116 to outlet 104. In an aspect of the present disclosure, the cracking pressure of valve 224 may be different than the cracking pressure of valve 226, such that valves 224 and 226 may provide a differential fluid flow from the fluid compartments 115, 116.

FIG. 2C illustrates an actuator in accordance with an aspect of the present disclosure.

FIG. 2C illustrates an exemplary actuator in the form of a detent mechanism 228 within actuator 202. Detent mechanism 228 allows actuator 202 to remain in one or more locations, due to increased resistance of actuator 202 in one or more locations along the rotational travel of actuator 202, where detent mechanism 228 is engaged. Detent mechanism 228 is shown as a spring-loaded ball, however detent mechanism can be any mechanism that allows for repeatable locations of actuator 202 without departing from the scope of the present disclosure.

FIG. 2D illustrates a housing in accordance with an aspect of the present disclosure.

FIG. 2D illustrates one or more detents 230 within housing 234. Detents 230 engage with detent mechanism 228 to provide increased resistance at one or more locations along the rotational travel of actuator 202 within housing 234. For example, and not by way of limitation, detent mechanism 228 can interact with detents 230 at locations that correspond to tubing 108 being fully closed, tubing 110 being fully closed, tubing 108 and 110 being equally open, etc.

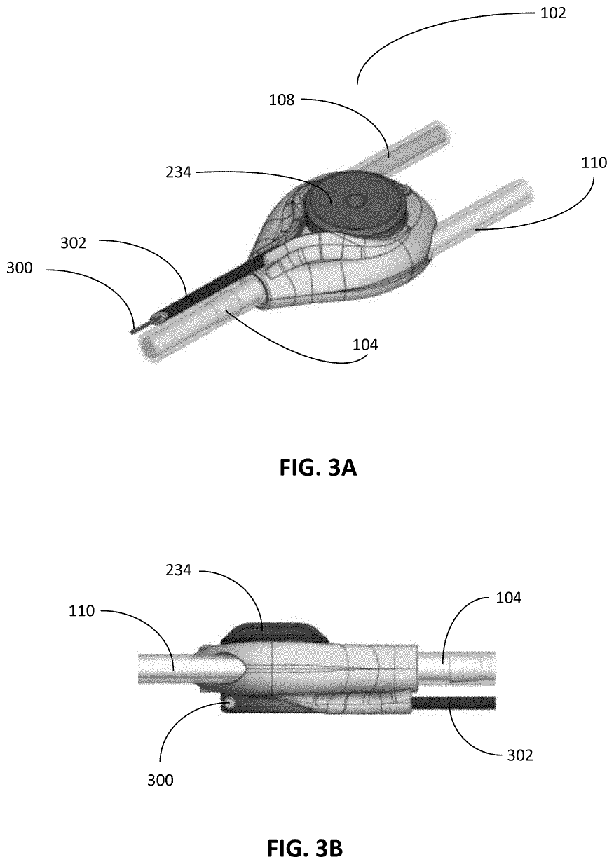

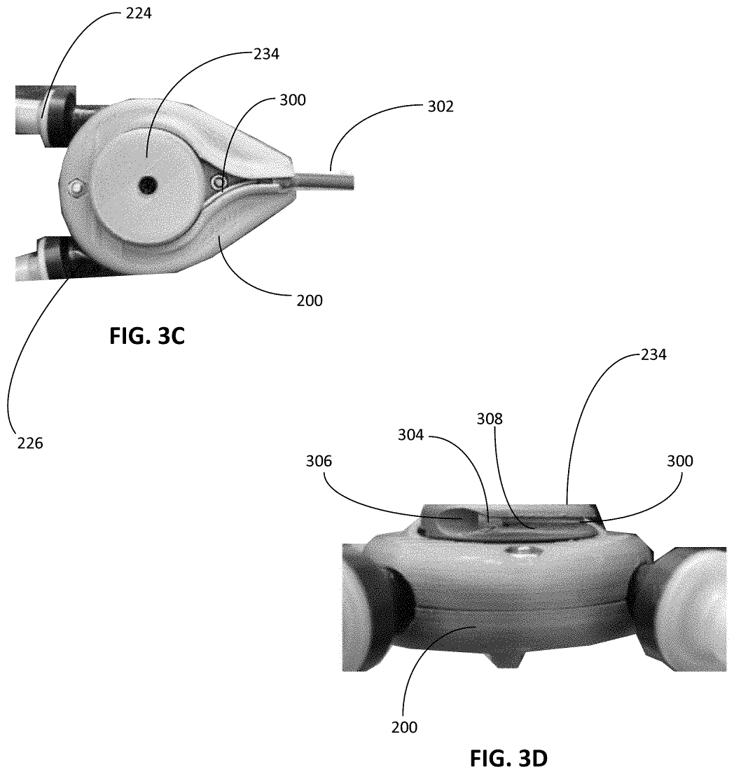

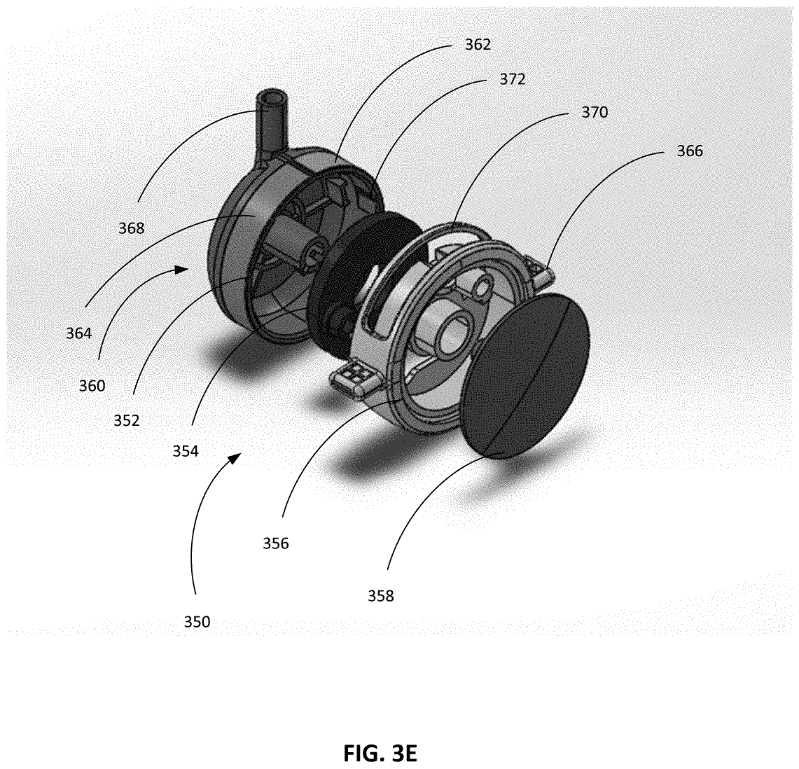

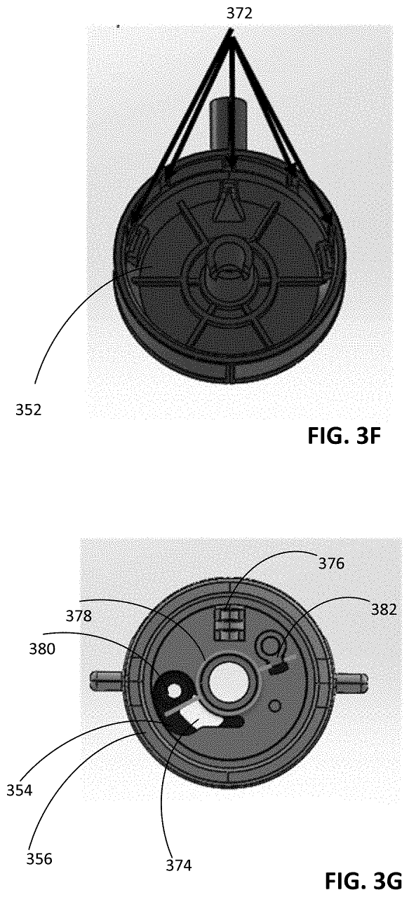

FIG. 3A illustrates a perspective top view of a fluid combining device in accordance with an aspect of the present disclosure. The fluid combining device of this embodiment may have a remote selector. As illustrate the control feature at the fluid combining device that works in conjunction with the remote selector to control the selector of the fluid combining device is illustrated.

Exemplary embodiments of the fluid combining device may include a remote selector. The remote selector may be configured to work in conjunction with a local selector. The fluid combining device of FIG. 3A may be similar to the fluid combining device as illustrated with respect to FIGS. 2A-2D. The fluid combining device of FIG. 3A may also include an interface to communicating with a remote selector.

In an aspect of the present disclosure, cable 300, which may be surrounded by cable housing 302, may be coupled to selector 105 such that selector 105 may be rotated from a distance away from selector 105. Selector 105 may be rotated directly, e.g., by turning selector 105 by hand. However, in an aspect of the present disclosure, it may be desirable to be able to move selector 105 from a different location. For example, and not by way of limitation, fluid combining device 106, and thus selector 105, may be somewhat inaccessible for a runner or bicycle rider while running and/or cycling. As such, cable 300 can be coupled to selector 105, and cable housing 302 can direct cable 300 to a remote selector that is easier to access for a user (e.g., hanging with the user delivery interface 102 or outlet 104, or attached to the user's clothing). Cable 300 may be a wire cable, monofilament line, rope, string, and/or other cordage without departing from the scope of the present disclosure.

FIG. 3B illustrates a side view of the fluid combining device having a control feature to interact with a remote selector in accordance with an aspect of the present disclosure.

As shown in FIG. 3B, one end of cable 300 may be coupled to selector 105, such that when cable 300 is moved, selector 105 rotates.

As such, in an aspect of the present disclosure, selector 105 may close off and/or limit the flow of fluid from one fluid compartment 115/116 by closing off and/or limiting the flow of fluid through tubing 108/110. As such, the amount of fluid flowing into wye 204 may contain different amounts of fluid from each of compartments 115, 116. Thus, a variable fluid concentration between the fluids flowing in tubing 108 and 110 (i.e., those fluids separately stored in compartments 115 and 116) can be achieved in an aspect of the present disclosure.

Because selector 105 allows for closing tubing 108 and/or 110 partially and/or completely, a user can control the amount of fluids being delivered through user delivery interface 102 at any given time. For example, and not by way of limitation, an endurance athlete may desire water without electrolytes at a certain point in their activity. Selector 105 may be placed in a certain position to allow the flow of water through tubing 108, while reducing and/or eliminating the flow of electrolyte fluid in tubing 110. Of course, placing selector 105 in another position could deliver only the electrolyte solution through tubing 110 without diluting the electrolytes with water from tubing 108, and other positions of control 106 may prevent the delivery of any ratio of fluids from tubing 108/tubing 110 through user delivery interface 102 and through the outlet 104.

FIG. 3C illustrates a top view of the fluid combining device having a control feature to interact with a remote selector in accordance with an aspect of the present disclosure.

FIG. 3C illustrates cable 300 travelling within housing 200 and interacting with housing 234 along the circumference and/or outer edge of housing 234.

FIG. 3D illustrates a rear view of the fluid combining device having a control feature to interact with a remote selector in accordance with an aspect of the present disclosure.

As discussed with respect to FIGS. 3A-3C, cable 300 interacts with housing 234. Cable 300 may include a termination 304 that engages a recess 306 in housing 234. Cable 300 may also engage housing 234 in a track 308 to maintain cable 300 in a desired orientation and/or position with respect to housing 234.

Recess 306 may have a larger diameter and/or other shape than track 308, such that termination 304 can engage with recess 306, but termination 304 is unable to enter track 308. In such an aspect of the present disclosure, termination 304 allows cable 300 to move housing 234. Since housing 234 is coupled to actuator 202, movement of cable 300 may move actuator 202.

FIG. 3E illustrates an exploded component few of a remote selector that working in conjunction with the fluid combining device having the control feature, such as those illustrated in FIGS. 3A-3D.

The remote selector 350 may include a body 352, spring disk 354, knob body 356, and face 358. The body 352 and face 358 may couple together to define terminal ends for retaining the spring disk 354 and knob body 356 between the body and face. The remote selector 350 may include outward projections 366 in which the user may control or make a selection through the remote selector 350. The user may engage these knobs 366 to rotate the knob 356 relative to the body 352.

The wire from the control feature of the fluid combining device may couple to the remote selector through a port 368 in body 352 and attach to knob 356 and/or spring disk 354. As the user rotates the knob 356, the wire is wrapped about axis within body 352 thereby putting tension on the wire and operating the control feature of the fluid combining device.

The spring body 354 may engage a spring and act as a biasing element against the rotation of the knob body 356 within body 352. The remote selector may include a spring loaded ball plunger. The remote actuator may maintain tension on the cable through a torsional spring coupled to the spring disk 354.

The remote selector 350 may also include an indicator 360 to indicate to a user the relative position of the selector, the relative opening of the fluid control mechanisms, and/or the relative composition of the resulting composition out of the fluid delivery device. For example, the body 352 may include a first color indicator 364 and a second color indicator 362. The color indicators may be colored lengths on the body 352. The exterior edge of the remote selector may be configured to cover at least a portion of the first color indicator 364 and/or the second color indicator 362. The exterior edge of the remote selector may have an opening in which a portion or all of the first color indicator 364 and/or the second color indicator 362 are visible. As illustrated, the knob body 356 includes an aperture 370. The indicator 360 is positioned within the knob body 356 and at least a portion of either the first color indicator 364 and/or the second color indicator 362 are visible to a user. As the user rotates the knob body 356, the proportion of the color indicator 360 (specifically the relative proportion of the first color indicator 364 to the second color indicator 362) visible through the aperture 370 changes to indicate a relative proportion of fluids from the respective compartments that are mixed into the composition dispensed from the fluid delivery device.

FIG. 3E illustrates a detent mechanism 372 within remote selector 350. Detent mechanism 372 allows remote selector 350 to remain in one or more locations, due to increased resistance of knob body 356 (or spring disk 354) with body 352 in one or more locations along the rotational travel of knob 366, where detent mechanism 372 is engaged. Detent mechanism 372 may include a plurality of detents on an inner surface of body 352. Only one detent is visible in FIG. 3E, but the body may include any number of detents, such as 2, 3, 4, 5, etc. A spring loaded ball plunger may be coupled to knob body 356 to impose resistance between the knob body 356 and the body 352. Although a spring-loaded ball plunger is described, detent mechanism can be any mechanism that allows for repeatable locations of knob 366 without departing from the scope of the present disclosure.

FIG. 3F illustrates the body 352 of remote selector 350 including the detents 372 on an interior surface of the body 352. The detents, as illustrated provide for select retention of the knob body 356 relative to the body 352. As illustrated, five detents are shown. The detents may therefore correspond to a fluid combination of one fluid relative to the entirety of the fluid being dispensed at (0%, 25%, 50%, 75%, and 100%).

FIG. 3G illustrates the knob body 356 of remote selector 352 with the spring disk 354 positioned behind and coupled to the knob body 356. The knob body 356 may include slot 374 for spring disk 354 such that the spring disk and knob body may engage and the knob body 356 can rotate the spring disk 354. The spring disk 354 may include a projection 380 that fits through the slot 374. The knob body 356 may also include a projection 382 extending in the same direction as projection 380 of spring disk 354. A spring 378 may be positioned around an axis of the knob body and engage the respective projections of the spring disk and the knob body to impose a biasing force on the relative position of the knob body and the spring disk. The bias imposed by the spring may be used to keep tension on the cable as the projection 380 is permitted to move within slot 374 of knob body 356. The knob body 356 may also include an insert 376 for the spring loaded ball plunger for engagement with detents of the body 352.

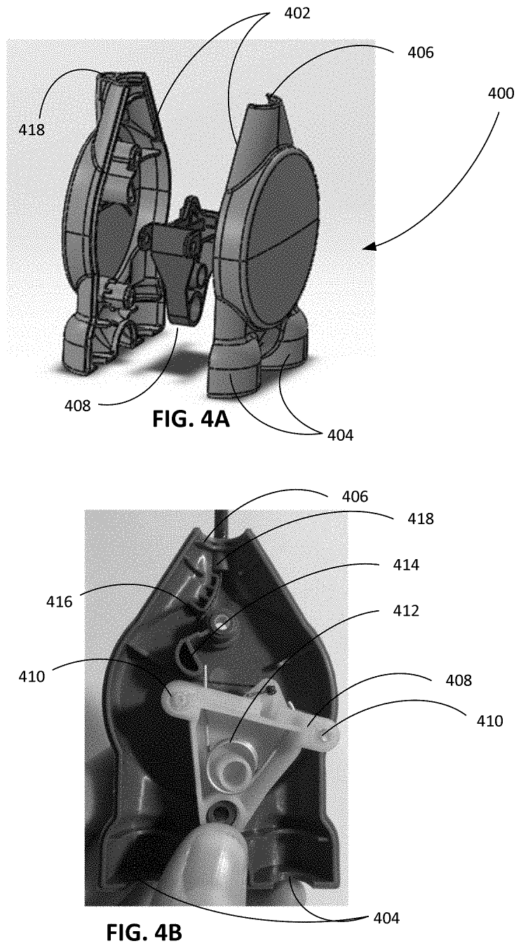

FIGS. 4A and 4B illustrate partial component views of a fluid combining device 400 according to embodiments described herein. Exemplary embodiments of the fluid combining device may be used in conjunction with features and components as described with other embodiments, such as, for example, FIGS. 2A-2D and/or FIGS. 3A-3G.

FIGS. 4A and 4B illustrate a fluid containing device in accordance with an aspect of the present disclosure. Exemplary embodiments of the fluid containing device provided herein may provide alternative fluid control mechanisms for regulating the fluid flow through the connectors and/or from the fluid containing device and provide a fluid out of the fluid delivery device in a desired and dynamically controlled composition.

FIG. 4A illustrates a partial component exploded view of a fluid combining device 400 according to embodiments described herein.

The fluid combining device 400 may be used with tubing, connectors, valves, etc. as described herein, but which are not included for sake of illustration and simplicity. The fluid combining device 400 may include housing 402. The housing 402 may be configured with inlet ports 404 and exit port 406. The inlet and exit ports may be configured to retain fluid connectors according to embodiments described herein, such as, for example, tubing, valves, etc.

FIG. 4B illustrates a cut away view to illustrate the internal cavity of the housing and select components within the housing of the fluid combining device 400.

The housing 400 may retain and enclose a fluid control mechanism 408. The fluid control mechanism in some respects is similar to the configuration illustrated in FIGS. 2A-2B, in which the corresponding description is understood to equally apply to the disclosure of the instant embodiment. For example, the fluid control mechanism 408 may be rotationally coupled to housing 402. The fluid control mechanism 408 may include projections 410 that are configured to extend outward and apply external pressure on the fluid connectors, such as tubes, to alter the fluid flow rates of the fluid passing through the fluid connectors by changing a cross sectional area of the fluid connectors. The fluid connectors are not illustrated in FIGS. 4A-4B for sake of simplicity, but are understood to be configured as described with respect to FIGS. 2A-2B, and otherwise described herein.

The fluid control mechanism comprise a biasing element to retain the fluid control mechanism is a select configuration. As illustrated, the fluid control mechanism 408 is coupled to spring 412 that contacts an internal side of the fluid control mechanism 412 to apply pressure on the fluid control mechanism and push the fluid control mechanism again one of the fluid passages to restrict flow through one of the fluid passages and leaving the other fluid passage unrestricted. This configuration results in the output solution from the fluid delivery device being from only one fluid contained within the fluid containing device. The spring engages an internal projection 414 within housing 402 to create the force applied on the fluid control mechanism 408.

The fluid control mechanism 408 may include an attachment point for attaching the remote connection to the remote selector. As illustrated a cable 416 is attached to the fluid control mechanism. The cable 416 is configured to run through the housing and out a passage 418 in the housing. The passage for the cable may be adjacent the output 406 for the fluid flow such that the remote selector may be positioned adjacent or proximate to the user delivery interface for ease of access. The cable 416 may extend from the fluid control mechanism 408 and wrap around the projection 412 used by the spring 412. The projection (either the same as for the spring or a separate projection or any other internal configuration of the housing) may be used to orient the cable to apply an directing force on the fluid control mechanism. As illustrated, the applied force from the cable is approximately tangential to the rotation of the fluid control mechanism. The projection is also sufficiently offset so that the full range of control of the fluid control mechanism may be achieve by pulling on the cable and the corresponding fluid control mechanism.

The fluid combining device may be operated by pulling on the cable, such as through remote selector as described herein, and rotating the fluid control mechanism away from one side of the housing toward the opposite side of the housing. Through the rotation, fluid is progressively released from the fluid flow connector on the one side of the housing and progressively restricted from the fluid flow connector on the opposite side of the housing. The composition of the resulting fluid out of the fluid combining device may therefore be dynamically adjusted. As the selector is moved in the opposite direction, the cable is loosened, and the biasing element may move the fluid control mechanism back toward the one side of the housing, thereby restricting the fluid flow through the fluid flow connector on the one side of the housing.

Exemplary embodiments of the fluid combining device of FIGS. 4A-4B may or may not have a local selector. As illustrated, the embodiment of FIGS. 4A-4B may be used with the remote selector as described in FIGS. 3E-3G, without a local selector at the housing of the fluid combining device. The remote selector may be configured to control the fluid control mechanism of the fluid combining device with an interface that is remote from the housing of the fluid combining device and/or separated from the fluid control mechanism.

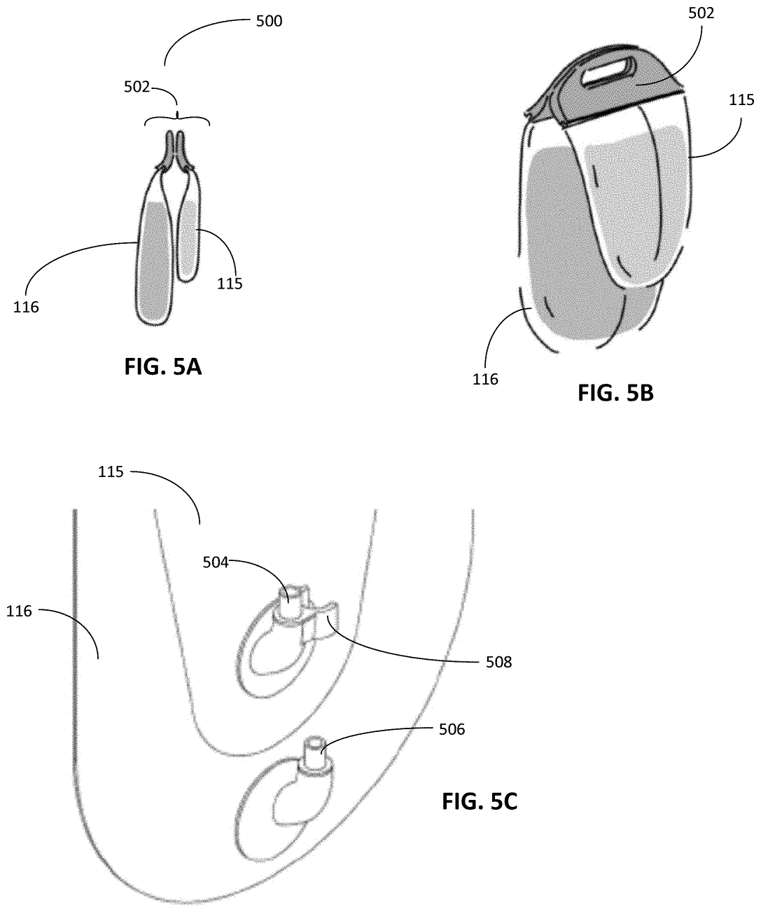

FIG. 5A illustrates a side view, while FIG. 5B illustrates a perspective view, of fluid containing device 500 in accordance with an aspect of the present disclosure. Fluid containing device 500 may comprise first compartment 115 and second compartment 116 and a coupler 502.

In an aspect of the present disclosure, coupler 502 may operate as a sealing device for one or more of compartments 115 and 116. In another aspect of the present disclosure, coupler 502 may operate as a carrying apparatus for compartments 115 and 116. Although shown in a particular shape in FIGS. 5A and 5B, coupler 502 may take any shape without departing from the scope of the present disclosure.

As shown in FIGS. 5A and 5B, first compartment 115 may be of a different size, shape, and/or volume compared to second compartment 116. However, in an aspect of the present disclosure, compartments 115, 116 may be of the same size, shape, and/or volume without departing from the scope of the present disclosure.

FIG. 5C illustrates a reservoir system in accordance with an aspect of the present disclosure.

As shown in FIG. 5C, compartment 115 may comprise an adapter 504, and compartment 116 may comprise an adapter 506. Adapter 504 and/or adapter 506 allow for tubing 108 and/or 110 to be coupled to compartments 115 and/or 116. In an aspect of the present disclosure, adapters 504 and 506 may be of the same size, length, shape, and/or other characteristic(s) to allow tubing 108 and tubing 110 to be coupled interchangeably to either compartment 115 and/or 116. However, adapters 504 and/or 506 may be of different sizes, shapes, and/or may have other differing characteristic(s) to allow unique coupling between tubing 108/110 and compartments 115 and 116.

Adapter 504 may also have a clip 508 attached to adapter 504 and/or elsewhere on one of the compartments 115 and/or 116. Clip 508 allows for the coupling of tubing from another compartment (in the case shown in FIG. 5C, the tubing coming from compartment 116) to be connected to the “other” compartment 115. Clip 508 may allow for tubing 108/110 to be more easily routed and/or managed within system 100.

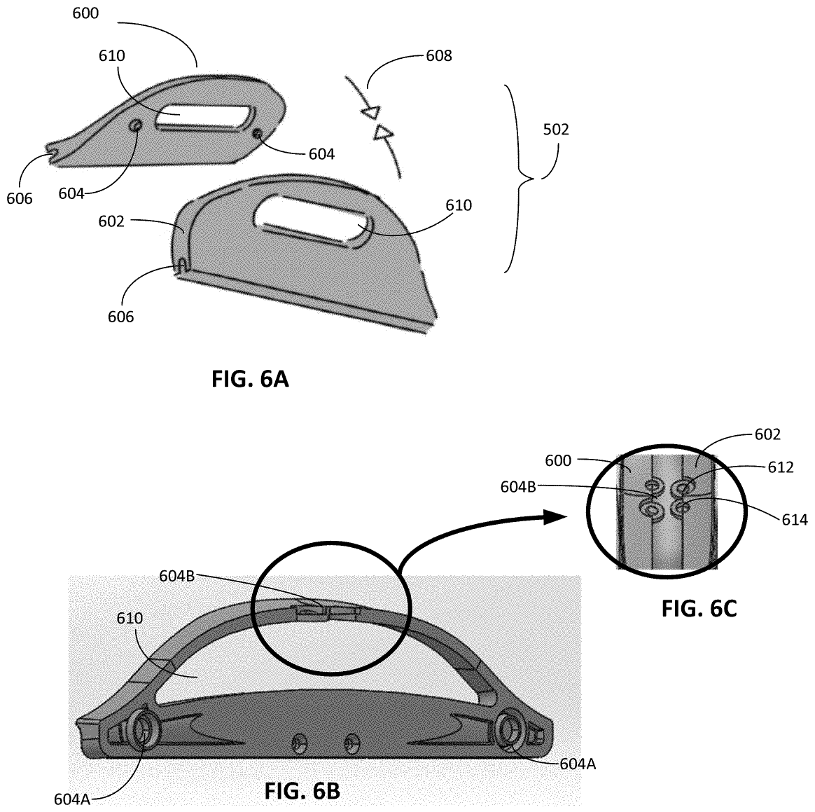

FIG. 6 illustrates a perspective view of a coupler in an aspect of the present disclosure.

FIG. 6 illustrates coupler 502, which may comprise frame 600 and frame 602. Additional frames may also be included as part of coupler 502 without departing from the scope of the present disclosure.

Each of frame 600 and frame 602 comprise one or more registration marks 604 and, in an aspect of the present disclosure, each of frame 600 and frame 602 comprise a channel 606.

In an aspect of the present disclosure, registration marks 604 allow for frame 600 to be properly aligned when coupled to frame 602 when frames 600 and 602 are brought together (illustrated by arrows 608). In another aspect of the present disclosure, registration marks 604 allow frame 600, and/or frame 602, to be coupled together and/or to another device, e.g., a backpack, carrier, and/or other bag such that frame 600, frame 602, and/or coupler 602 can be secured to such a device. In an aspect of the present disclosure, other methods for securing frame 600, frame 602, and/or coupler 602 can be employed to secure coupler 602, and thus fluid containing device 114, including fluid compartments 115, 116, to be coupled to an external housing, such as a bag. For example, and not by way of limitation, opening 610 may be employed as a connection port and/or location for coupler 602 to be coupled to an external device, backpack, bag, etc. The handle created by opening 610 may also include the registration marks, additional attachment features to couple the frame 600 and frame 602 together, and/or provide a carrying location for a user as the fluid containing devices, such as when inserted and/or removed from an external device, if present.

FIGS. 6B and 6C provide more detailed partial views of the coupler 502 according to embodiments described herein.

The handle portion of the coupler of each of the frames may include one or more registration features. The registration feature may be a mated interface that may be used to align one frame to another frame during coupling and/or assist in or attach one frame to the other frame. As illustrated, a pair of registration features 604A may be configured as indent, detent pairs so that a projection on one frame is configured to fit within an indentation of the other frame. The registration feature 604A may be magnetic such that one frame is attracted to the other frame and coupled together. As illustrated a pair of registration features 604B may be configured as mated, coupling interfaces. The mated coupling interface, as illustrate comprises two projections for one mated side. One of the projections has an opening 614, and a second of the projections has a detent 612 (and second projection). The detent is configured to mate with the opening of the other mated side, while the opening is configured to mate with the detent of the other mated side.

In an aspect of the present disclosure, channel 606 may couple frame 600 and/or frame 602 to fluid containing device 114, such as compartments 115 or 116. In an aspect of the present disclosure, the channel 606 in frame 600 may differ in size, length, shape, and/or other characteristic(s) from channel 606 in frame 602. In such an aspect, frame 600 may be uniquely designed to couple to one of compartment 115, while frame 602 is uniquely designed to couple to the other reservoir 116. Of course, channel 606 may be substantially similar in both frame 600 and frame 602, allowing either frame 600 or 602 to couple to either of compartments 115, 116 without departing from the scope of the present disclosure.

In an aspect of the present disclosure, channel 606 may operate as more than just a coupling area for compartments 115, 116. For example, and not by way of limitation, channel 606 may be shaped, designed, and/or sized to assist in and/or perform the sealing of an opening in compartments 115 and/or 116.

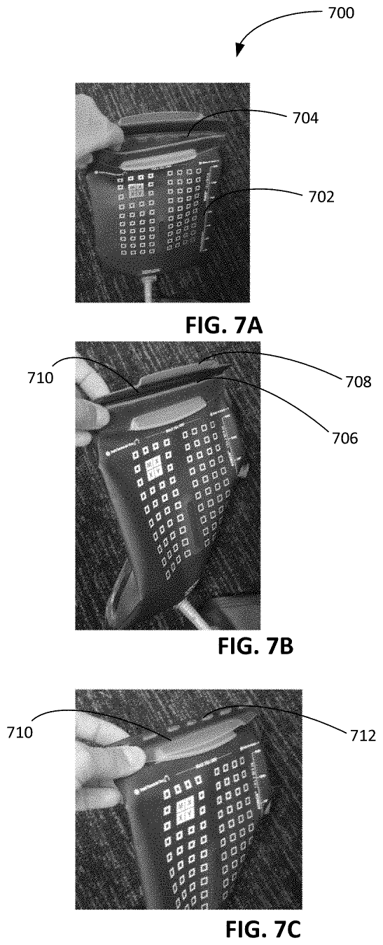

FIGS. 7A-7C illustrate different perspective views of an exemplary fluid containing device according to embodiments described herein in different configurations. FIG. 7A illustrates the fluid containing device in an open configuration, FIG. 7B illustrates the fluid containing device in a transition configuration, while FIG. 7C illustrates the fluid containing device in a closed configuration. When in the closed configuration, the fluid containing device may be coupled to coupler 502, such as at channel 606. The fluid containing device 700 described herein may be an exemplary configuration of either or both of the fluid compartments 115, 116.

The fluid containing device 700 may comprise a housing 702 defining an interior cavity for retaining a fluid. As illustrated, the housing is in the form of a flexible bag. The bag may permit the interior cavity to expand or contract with the addition of a fluid within the internal cavity. The fluid containing device 700 may have an opening 704 at the “top” (portion of the housing that is coupled to frame 600 and/or frame 602) to allow for ease of filling and/or cleaning the fluid containing device 700. This opening 704 in housing 702, if it were left open in some fashion, would allow any fluids to leak from the housing. Channel 606, described with respect to FIG. 6A, may provide pressure around (and/or along) such an opening to substantially prevent leakage of fluid through opening. Many possibilities for the shape, design, and/or sizing of channel 606 and/or opening are possible without departing from the scope of the present disclosure.

The housing may comprise a first terminal end 706 and a second terminal end 708. The housing at and/or adjacent to the terminal ends 706, 708 may define the opening 704. As seen in FIG. 7B, the first terminal end may be shorter or terminate before the second terminal end 708. In other words, the second terminal end may be co-extensive with the first terminal end, and then extend past the first terminal end. The second terminal end 708 may therefore provide a lip that can be folded over and cover the opening 704 and the first terminal end 706.

The housing 702 may also include projections 712. When the second terminal end 708 is folded over the opening 704, the projections 712 may be configured and extend on opposing sides of the housing. The projections 712 may comprise two parallel lines of projections on a surface of the flap created before the second terminal end on one side of the housing 702. When the second terminal end is folded over the opening, the two parallel lines of projections may substantially align to define a single engagement surface. The single, linear engagement component configured to slidingly mate with channel 606 of coupler 502. As illustrated, the line of projections is a discontinuous line, but the projection may be a continuous line of projections and not depart from the present disclosure.

As illustrated, the fluid containing device 700 comprising a single housing defining a single internal compartment. The fluid compartment may also or alternatively be separate compartments within fluid containing device 700, such that the single housing comprises a divider to create the two compartments with each compartment having its own exit port and associated fluid connector. The opening of fluid containing device may provide access to one of the compartments and/or both of the compartments. The flaps described herein may be separated such that the compartments may be separately and individually opened.

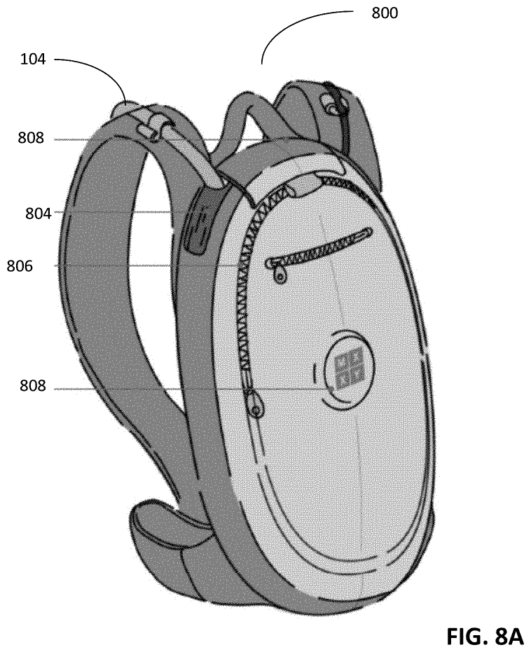

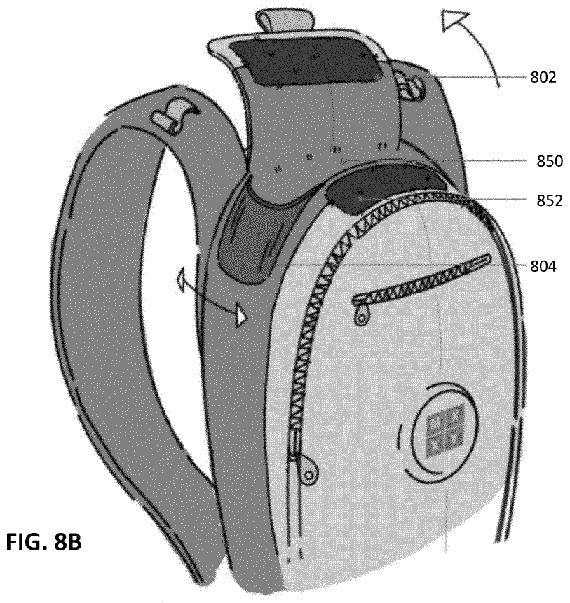

FIG. 8A illustrates a storage holder in accordance with an aspect of the present disclosure.

Holder 800, which may be a backpack, purse, sling bag, and/or other pouch for holding, transporting, and/or containing system 100, may comprise closure 802, elastic 804, pocket 806, and/or logo 808.

Closure 802 may be a flap, zipper, or other mechanism to allow selective access to a pocket and/or other compartment within container 800 that is designed to hold system 100. Such a compartment may be insulated and/or otherwise separated from other compartments within container 800 to protect system 100 from damage, heat, and/or interaction with other items that may be placed within container 800.

Elastic 804 may be a stretchable fabric, hook-and-loop closure, and/or other selectable opening in container 800 that allows for access to a compartment designed to hold system 100. For example, and not by way of limitation, elastic 804 may be a stretchable fabric that allows for fluid connector (tubing) to outlet 104 to extend from such a compartment to an external location for ease of access by a user and/or wearer of container 800. Other possibilities for elastic 804 are possible within the scope of the present disclosure.

Pocket 806 may also be included as part of container 800. Pocket 806 may be used to store items other than system 100, e.g., energy bars, paperwork, airline tickets, additional electrolyte powder mix, etc. Pocket 806 may, in an aspect of the present disclosure, have additional complete and/or partial access to the compartment normally accessed by closure 802.

Logo 808 may be included as part of container 800 to indicate that container 800 can be used with system 100 if desired.

FIG. 8B illustrates a storage container in accordance with an aspect of the present disclosure.

Closure 802 is shown in an “open” position, which allows a view into compartment 850. Compartment 850 may be designed for holding system 100 within holder 800. Closure 802 may be closed to more securely contain system 100 within container 800, by coupling closure 802 to fastener 852. Fastener 852 may be a snap, hook-and-loop closure, or other means for closing the opening to compartment 800.

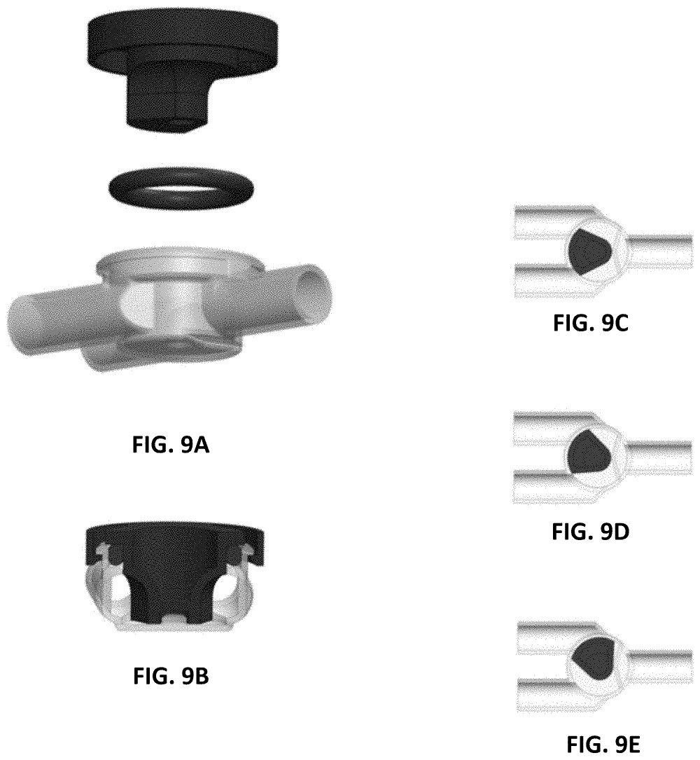

FIGS. 9 through 34 illustrate exemplary component parts according to aspects of the present disclosure.

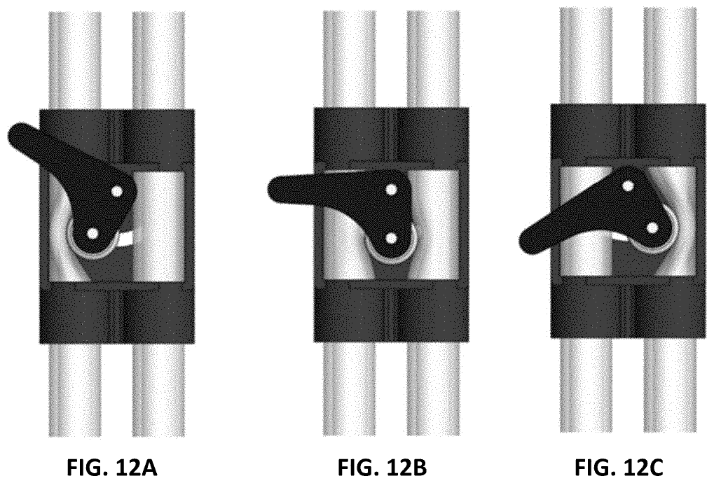

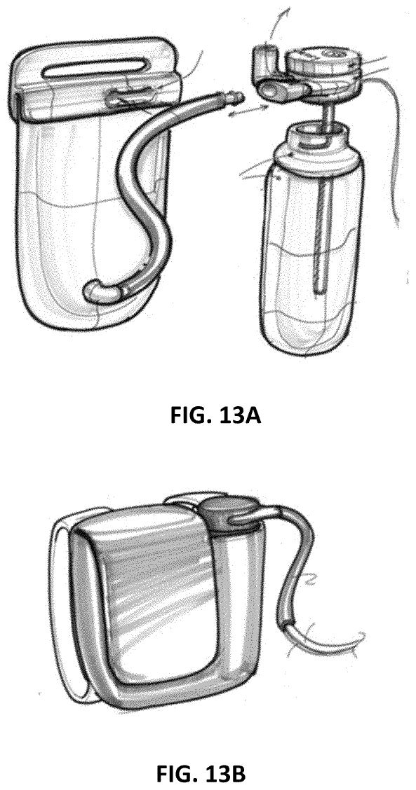

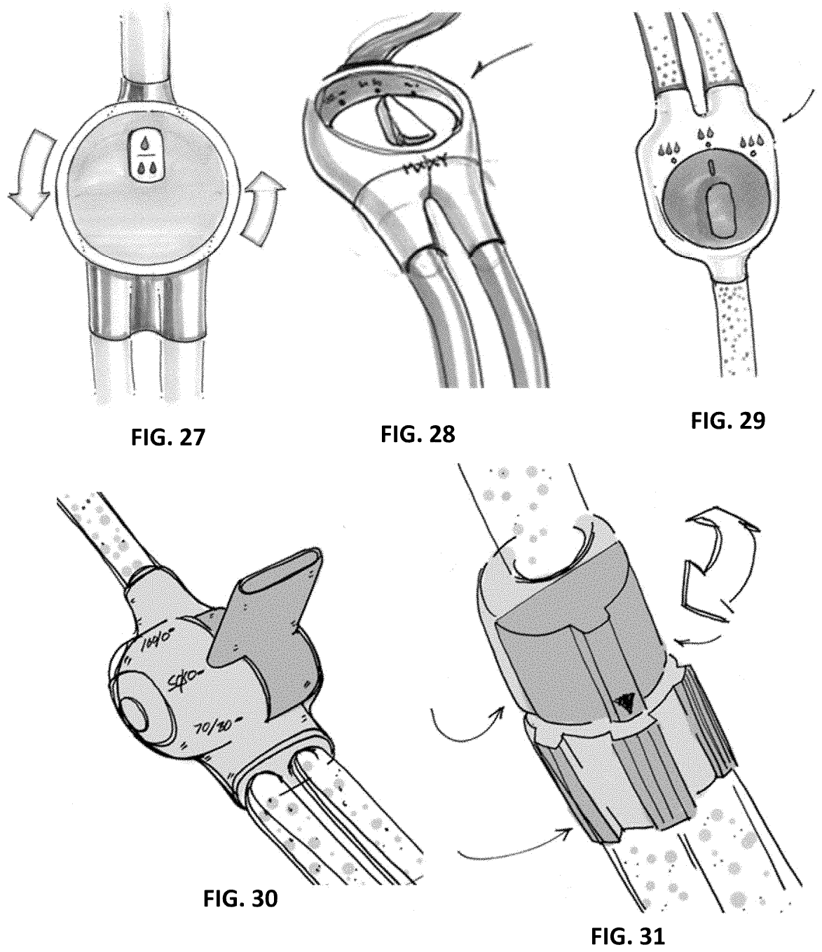

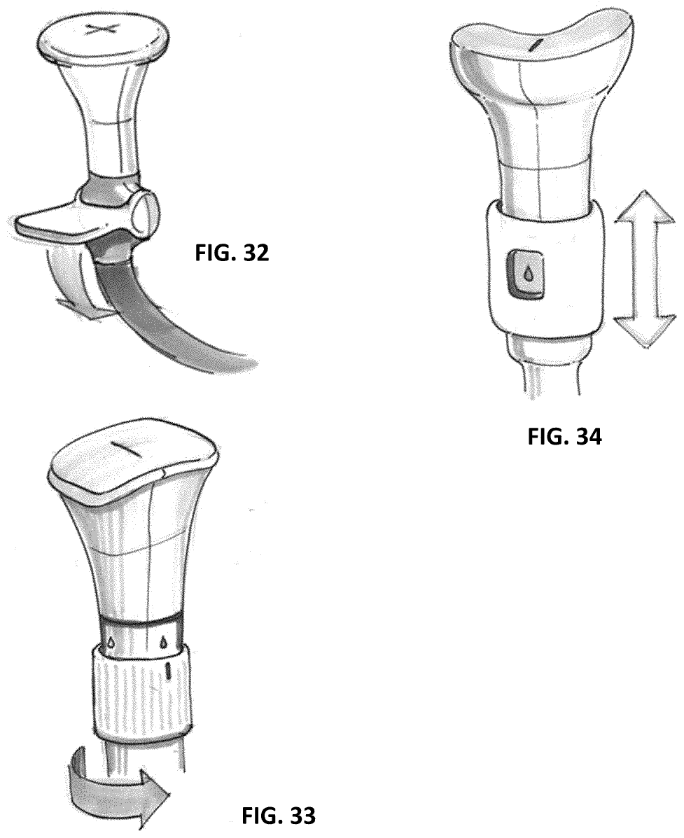

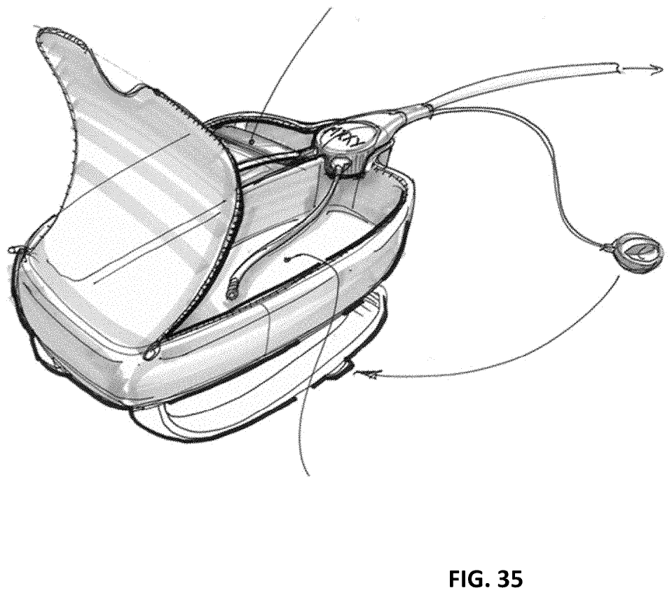

The exemplary component parts illustrated and described in relation to FIGS. 9 through 34, including exemplary embodiments of fluid combining devices, fluid control mechanism, selector, indicators, fluid containing devices, user delivery interface, and holders may be incorporated in any combination into any other embodiment provided herein and/or may replace, be added to, supplement, or otherwise be combined in any combination with any other components as provided herein. For example, any of the fluid combining devices and/or selectors of FIGS. 9 through 12 may be used with any of the fluid containing device of FIGS. 13 through 26, may be used with any selector and/or indicator of FIGS. 27 through 31, may be used with any user delivery interface, fluid control mechanism, and/or indicator of FIGS. 32 through 34, may be used with the holder of FIG. 35; and any combination of the preceding may be used in place of or in combination with any of the system and/or components of FIGS. 1-8.

FIG. 9A is a partial component exploded view, FIG. 9B is a cross sectional, cut-away view, and FIGS. 9C through 9E are exemplary positional configuration views of an exemplary fluid combining device according to aspects of the description.

The exemplary fluid combining device of FIGS. 9A-9C include a housing having at least two fluid inputs and at least one fluid output. The housing receives a portion of fluid control mechanism configured to adjust the cross sectional areas, and therefore the corresponding flow rates of the fluid inputs. Accordingly, by adjusting the fluid control mechanism different combinations of fluid mixtures may be achieved at the fluid output.

The housing defines a cavity in which the fluid inputs and the fluid output comes together. The flow control mechanism is pivotally coupled to the housing. The flow control mechanism comprises a tapered or wedge shaped profile that partially fills the cavity. As the flow control mechanism is rotated, it may partially or complete eclipse the apertures of the fluid input. For example, as illustrated in FIG. 9C, the flow control mechanism is at a central position so that the flow control mechanism is symmetrically positioned between the first fluid flow input and the second fluid flow input. The fluid from either input is equally able to flow past the fluid control mechanism and into the fluid flow output. As the fluid control mechanism is rotated, as seen in FIG. 9D, more of the fluid flow mechanism eclipses the fluid flow path from the first fluid flow input, while reducing the interference with the fluid flow path from the second fluid flow input. Therefore, as illustrated, less of the fluid from the first fluid flow path is permitted to pass the fluid flow mechanism thereby offsetting the mixture composition accordingly. FIG. 9E represents the fluid control mechanism in an extreme position such that it blocks an entirety of the fluid flow from one of the fluid flow inputs. As such, the fluid flow output comprises only the fluid through the unobstructed fluid flow path.

The operation of the fluid flow mechanism is similar to the operations of other fluid flow mechanisms by dynamically changing the relative cross sectional area of the flow paths from the first fluid flow input and the second fluid flow input. However, instead of physically deforming the fluid flow conduit (the tube), the fluid flow mechanism mechanically blocks or interferes with the flow path directly.

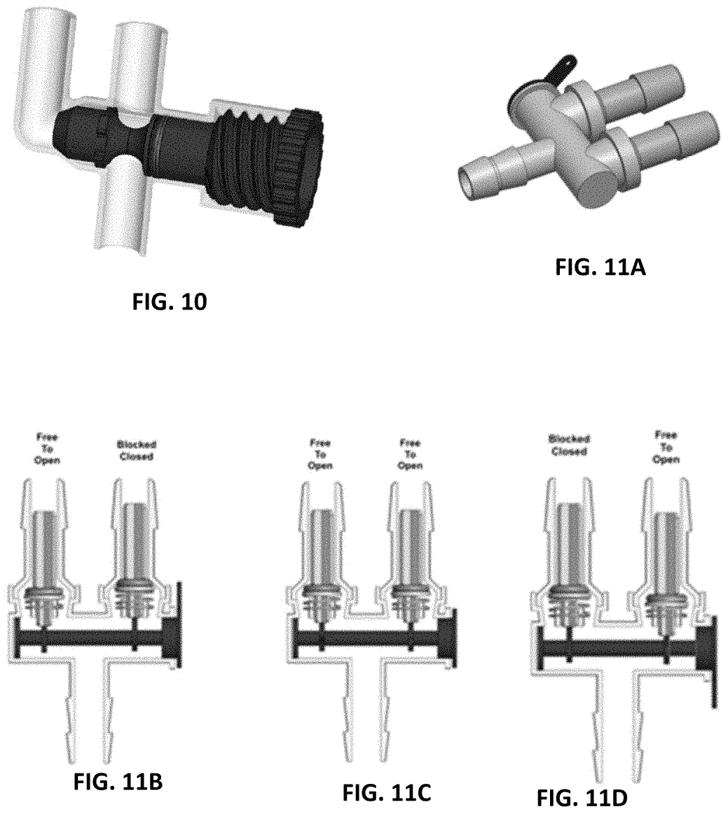

FIG. 10 is an exemplary component, cut away view of an exemplary fluid combining device according to aspects of the description.

FIG. 10 illustrates an exemplary embodiment of a fluid combining device having a housing defining two fluid inputs and a fluid output. The fluid control mechanism is configured to affect the fluid flow paths from the first fluid input and the second fluid input by blocking a portion or all of the passage to the fluid output. The fluid combining device has a fluid control mechanism in the form of a plunger. The plunger obstructs a first fluid input by traversing the passage of the fluid flow and obstructs a second fluid input by abutting and/or plugging the entrance of the second fluid input to the fluid output. As illustrated, the plunger has a contoured side profile, and as the plunger traverses across the first fluid flow path, the cross sectional area obstructed by the plunger is different. Similarly as the plunger approaches and or is removed from the connection between the second fluid flow path and the output, a variable flow rate is permitted. The translation of the plunger may be through frictional, slide engagement with the house, screw engagement, or other attachment.

FIG. 11A is a perspective view, and FIGS. 11B, 11C, and 11D are positional configuration views of an exemplary fluid combining device according to aspects of the description.

FIGS. 11A-11D illustrates an exemplary embodiment of a fluid combining device having a housing defining two fluid inputs and a fluid output. The fluid combining device comprises a fluid control mechanism comprised of a valve positioned in each of the respective fluid inputs. The valves are configured to open and close to effect the fluid flow from each of the fluid inputs. As illustrated, the fluid control mechanism comprises a shaft directly coupled to the selector that is configured to be rotated by a user relative to the housing. The shaft is coupled to plungers that are configured to move into (and thereby block) and move away from (and thereby unblock) the passages of the fluid inputs. The shaft works similar to a camshaft that can move the plungers into and out of seated positioned and seal and unseal the corresponding inputs. The plungers may be directly coupled to the shaft such that rotation of the shaft moves the plungers into a desired position. The plunger may be uncoupled from the shaft, and the shaft merely provide a limiter on the movement of the plungers. The plungers may therefore act as a one way valve. As the fluid flows, the plunger may be permitted to move in response to the fluid flow to a point limited by the position of the shaft.

FIGS. 12A, 12B, and 12C are positional configuration views of an exemplary fluid combining device according to aspects of the description.

FIGS. 12A-12C illustrate a fluid combining device having two fluid inputs and two fluid outputs. The fluid combining device of this embodiment may not include a fluid chamber in which the first fluid from the first input is physically mixed with the second fluid from the second input. The mixing in this case may occur at the user delivery interface or elsewhere in the system. This configuration may separate the fluids over a larger portion of the system. Exemplary embodiments of the fluid combining device of this embodiment are similar to those of FIGS. 2A and 2B in which a pivoting fluid control mechanism is configured to change a cross sectional area of the fluid flow passages by physically compressing a portion of the tubes defining the flow paths. As illustrated, the fluid control mechanism is coupled to a housing through a pivotal engagement. The fluid control mechanism is permitted to pivot about the attachment point to move a lever arm closer to and/or away from the fluid flow conduits of the first input and/or the second input.

FIG. 13A is a perspective, component, separated view, and FIG. 13B is a fully assembled, perspective view of exemplary embodiments of a fluid containing device and holder according to aspects of the description.

FIGS. 13A-13B illustrate an exemplary embodiment in which the fluid containing device may be a combination of separate fluid containers. As illustrated, one container may be a bag and one container may be a bottle. The cap of the bottle is illustrated as containing the fluid combining device according to any of the embodiments described herein. The fluid containing device of the bottle may also be subdivided and the two fluid inputs are configured to be in fluid communication with fluid compartments of the same bottle and not to an external bag. The system in this case may include two tubes or straws that extend into separated cavities of the bottle. Any of the fluid combining devices described herein may be integrated into the bottle cap to selectively mix the fluids before existing to a user delivery interface. This embodiment may permit the user delivery interface, the selector, the fluid combining device, and the fluid containing device (the bottle) to be in close proximity and/or directly couple to any combination of each other. For example, the fluid containing device (the bottle) may directly attach to the cap which defines the housing for the fluid combining device that also directly supports the selector, and the user delivery interface is a port in close proximity to the cap. FIG. 13B illustrates an exemplary embodiment of the holder having separate compartments for each of the fluid compartments.

Exemplary embodiments of the bottle may similarly inform an exemplary embodiment of the fluid containing device as a cooler. The bottle shape may be enlarged and the respective compartments as subdivisions of an interior space of the cooler body. The fluid combining device may be integrated into the housing of the cooler directly and/or into the lid of the cooler. The user delivery interface may be in the form of a hose, spigot, dispenser, etc. The use of the fluid delivery device as a cooler may provide an interface for larger events or more use, such as at athletic events for a team to use and have individuals dynamically adjust the concentration of the respective fluids for individual consumption. Similarly, such as at social gatherings, the cooler may include lemonade and iced tea so that guests can individually select one beverage, the other beverage, or a desired mixture of the two beverages and permit individual tailoring between different users.

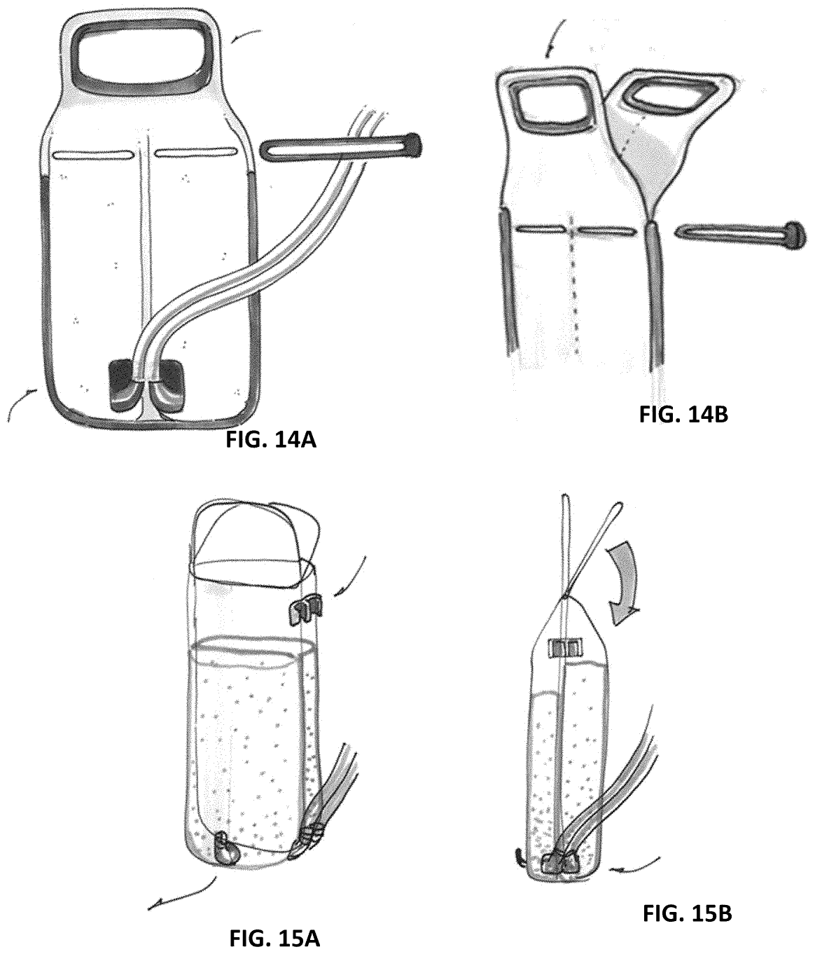

FIG. 14A is a front view and FIG. 14B is a partial perspective view of a fluid containing device according to aspects of the description.

FIGS. 14A-15B illustrate an exemplary fluid containing device in which a single container device an exterior surface that is subdivided into separate compartments to define the first compartment and the second compartment. Each compartment may include its own port and connection tubes. Also illustrated is a sealing device configured to clamp over an opening of either or both of the openings to the respective compartments in order to close the compartments and seal the fluid containing device. As illustrated, the sealing device comprises a body having parallel surfaces that are configured to slide over the open end of the fluid containing device. The fluid containing device comprises a projection in which the sealing device may slide over and frictional engage. The sealing device may be configured to apply pressure at the projection to seal the compartments.

FIG. 15A is a front, perspective view and FIG. 15B is a side view of a fluid containing device according to aspects of the description.

FIGS. 15A-15B illustrate an exemplary fluid containing device in which the output ports and/or the connectors are positioned on a side of the fluid containing device. The fluid containing device also includes one or more support structures. The support structures may be configured to removably couple to the fluid connectors (the tubes) in order to retain the system in a compact position, and/or may include a hook or other structure for holding the fluid containing device, such as to the external holder and/or when the fluid containing device is not in use. As illustrated the fluid containing device comprises a hook at the end of the fluid containing device at an opposite end from the end of the device comprising the opening. In this way, the fluid containing device may be hung when not in use to permit the fluid containing device to empty and dry effectively.

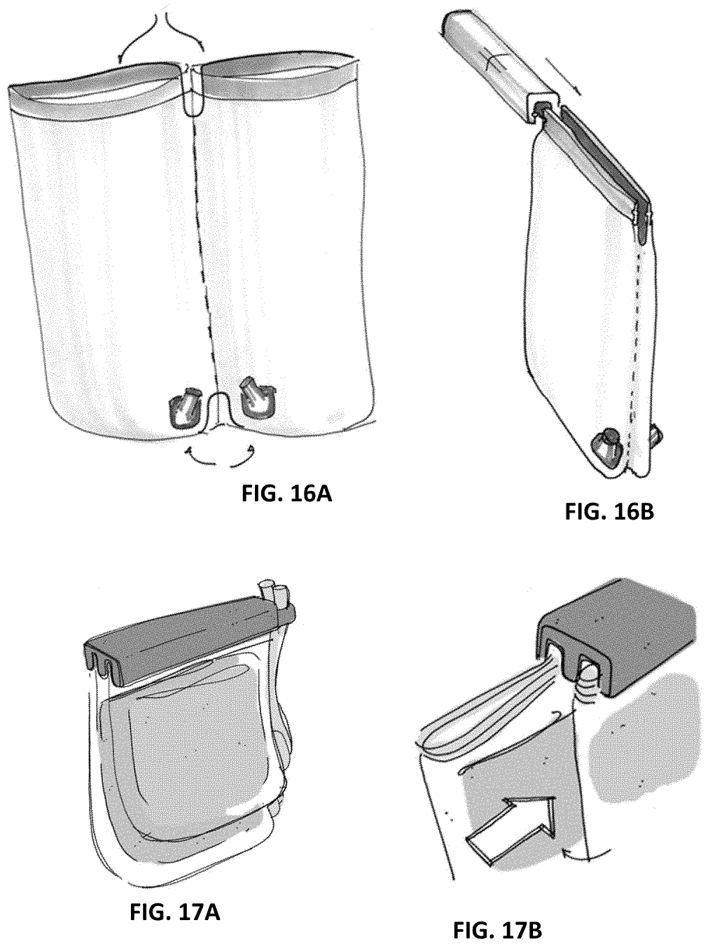

FIG. 16A is a front, perspective view in an open configuration and FIG. 16B is a perspective view in a transition configuration to being closed of a fluid containing device according to aspects of the description.

The fluid containing device of FIGS. 16A-16B comprise a single body subdivided into separate fluid compartments. The fluid containing device is configured to fold along an axis between the two compartment. The fluid containing device also includes a sealing device configured to slide over the open end of the fluid containing device and retain the device in a closed position.

FIG. 17A is a front, perspective view in a fully closed configuration and FIG. 17B is a partial, perspective view in a transition configuration to being closed of a fluid containing device according to aspects of the description.

Similar to FIGS. 16A-16B, the fluid containing device of FIGS. 17A-17B use a sealing device in which the fluid compartments may be slid into a channel and sealed thereby. However, FIGS. 17A-17B illustrate an embodiment in which the fluid compartments are contained within separate containers, and the sealing device may separately engage each of the fluid compartments individually. Also illustrated, similar to the fluid containing device of FIGS. 15A-15B, the fluid containing device has a support structure. The support structure is positioned on the sealing device as opposed to the compartments. As illustrated, the support structure comprises a retainer for removably attaching the fluid connectors for the fluid inputs into the respective compartments. In this embodiment, the sealing device may be integrated into the coupler such that after the compartments are attached to and sealed by the sealer, the fluid compartments are retained and coupled together through the coupler.

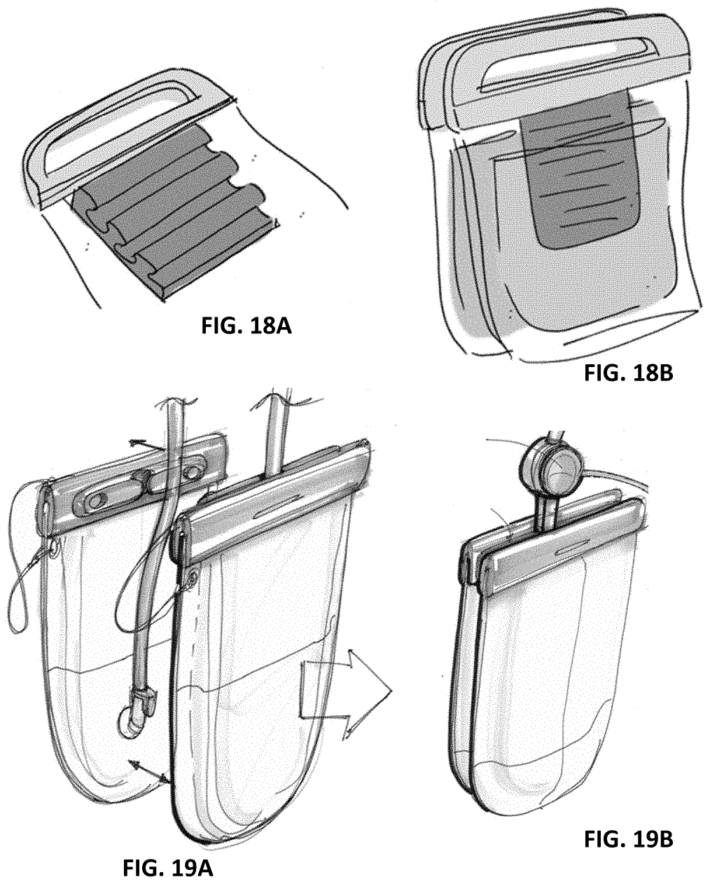

FIG. 18A is a front, perspective, partial component view and FIG. 18B is a perspective view in a fully closed configuration of a fluid containing device according to aspects of the description.

FIGS. 18A-18B illustrate an exemplary fluid containing device in which the coupler comprises mated surfaces that are attached to the respective fluid compartments. A mated surface of the coupled attached to the first compartment may be configured to engage the corresponding mated surface of the other compartment. The compartments may therefore be configured to removably attach to each other through the coupler. In this embodiment, the coupler is separate from the sealing device.

FIG. 19A is a front, perspective, separated component view and FIG. 19B is a perspective view in a fully closed configuration of a fluid containing device according to aspects of the description.

The fluid containing device of FIGS. 19A-19B illustrate another embodiment of a coupler comprises separate components attached to respective individual fluid compartments that comprise mated surfaces to engage and couple the parts of the coupler together and thereby the attached compartments. In this embodiment, the different parts of the coupler are integrated into the sealing device to the respective compartments. Also as illustrated, the coupler may be configured and/or shaped to accommodate a portion of the fluid connectors, such as the tubes to retain the system in a compact configuration when coupled together. Also as illustrated, a retaining device may be incorporated between the housing defining the compartment of the fluid containing device and the coupler (and/or the sealing device if the coupler is separate from the sealing device). As illustrated, a tether is provided by the sealing device and the housing defining the fluid compartment so that when the sealing device is removed from the compartment to open the compartment, the sealing device is retained thereto and not lost during filling, and/or storage.

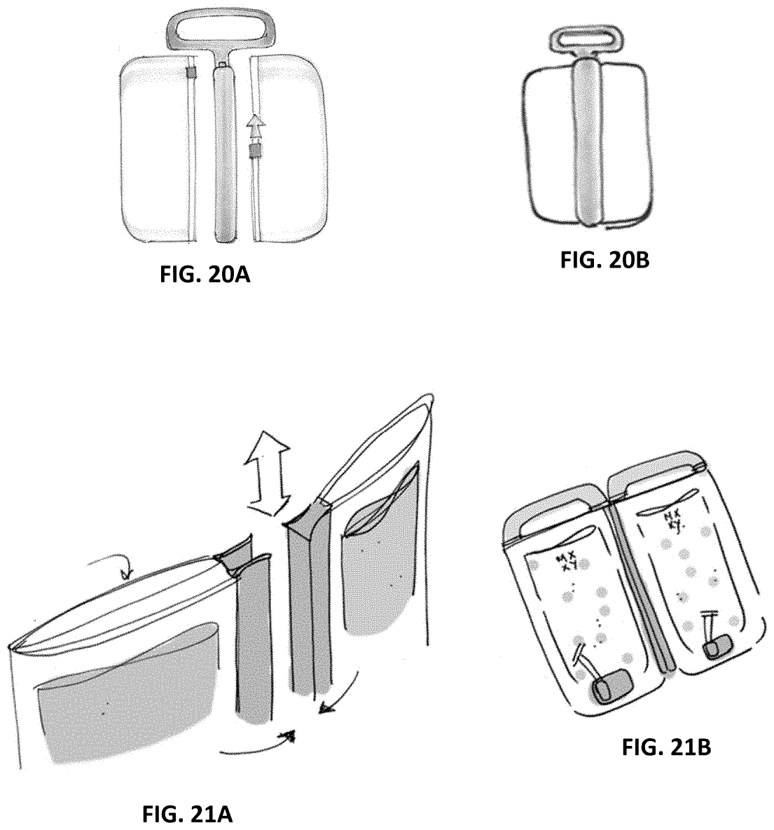

FIG. 20A is a front, separated component view and FIG. 20B is a side view in a fully closed configuration of a fluid containing device according to aspects of the description.

The fluid containing device of FIGS. 20A-20B illustrate a separate sealing device use for the respective compartments in conjunction with the coupler and/or with a second sealing device integrated into the coupler. In this embodiment, the sealing device is a mated feature at the exterior edge of opening to the container that is configured to be coupled, such as through a zipping action. The closed compartment may then be coupled to the coupler and/or the coupler may be configured to provide additional sealing. Also illustrated, the coupler may provide a rigid structure or frame. The coupler may extend across the compartments (such as along a top side, and/or from top to bottom). The frame may be used to keep the container is a desired configuration and/or position when inserted into an external holder according to embodiments described herein.

FIG. 21A is a front, perspective, separated, partial component view and FIG. 21B is a perspective view in a closed configuration of a fluid containing device according to aspects of the description.

The fluid containing device of FIGS. 21A-21B illustrate a coupler integrated into the compartment, which is separate from the sealing device. The coupler in this configuration is not separable from, but is integrated into the respective compartments. The coupler comprises a mated interface from one side of the coupler attached to the first compartment to the other side of the coupler attached to the second compartment. The fluid compartments may be configured to fold about the coupler to provide a more compact configuration of the fluid containing device. Each port of the fluid compartment may also be offset so that when folded the ports are out of alignment and do not contact.

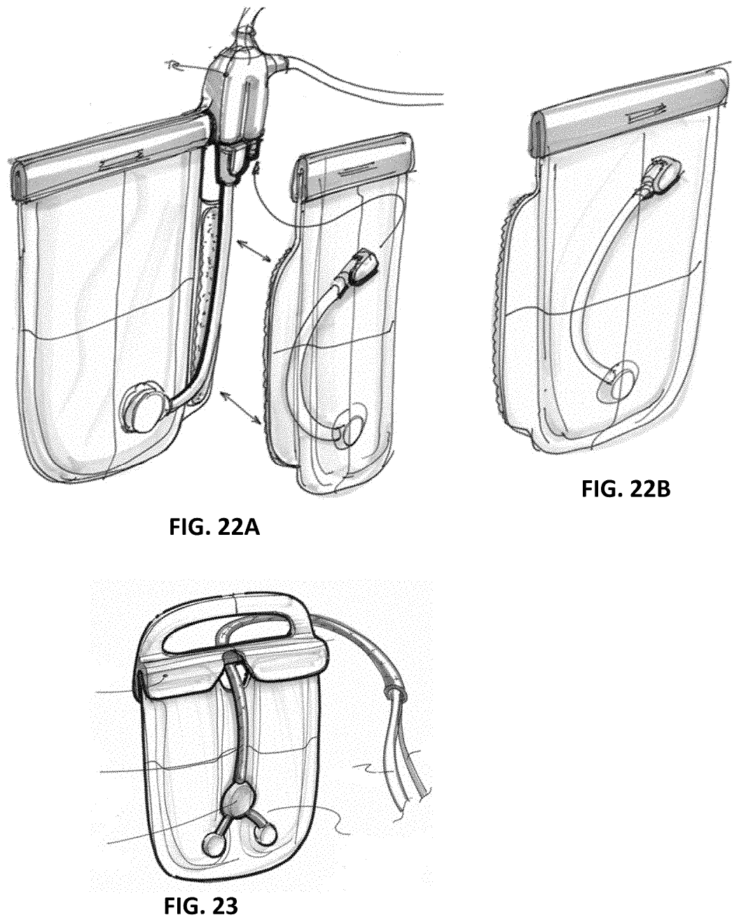

FIG. 22A is a front, perspective, separated component view and FIG. 22B is a separate component, perspective view of a fluid containing device according to aspects of the description.

The fluid containing device of FIGS. 22A-22B illustrate different coupler interfaces. As illustrated the fluid compartment may comprise a hook and loop mated structure between the fluid compartments. The fluid delivery device may also comprise a system that permits interchangeable attachment of different compartments that define the fluid containing device. As illustrated, a first configuration may use two fluid compartments of different size. However, if a user desires a more even combination of fluids, the use may interchange a smaller fluid compartment for a larger one. The system may therefore be modular and the respective fluid compartments selected for the given situation. Also as illustrated, the fluid combining device may integrate the coupler. As illustrated, the fluid combining device may comprise an interface in which the sealing device of the respective compartments may be configured to attach.

FIG. 23 is a front perspective view of an exemplary embodiment of a fluid containing device according to aspects of the description.

The fluid containing device of FIG. 23 illustrates the incorporation of the fluid combining device. In this embodiment, the fluid combining device is coupled to the respective compartments in close proximity to the ports from the compartments.

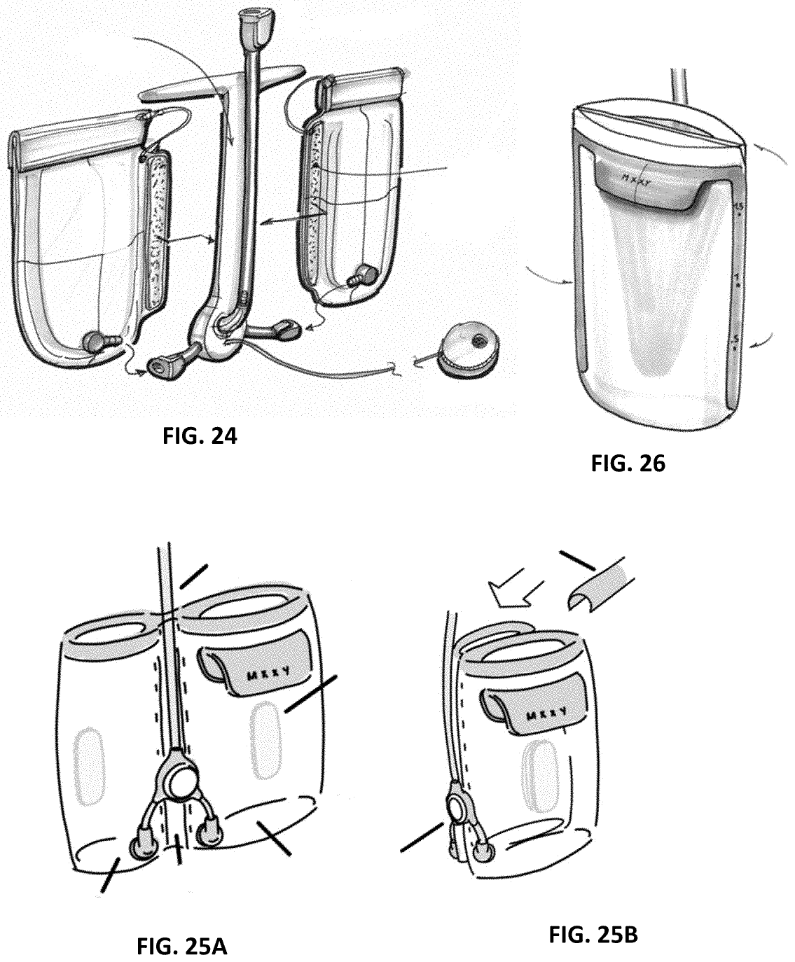

FIG. 24 is a front perspective view of an exemplary embodiment of a fluid containing device according to aspects of the description.

The fluid containing device of FIG. 24 illustrates an embodiment in which the fluid compartments are separate fluid containers that may be individually coupled to a coupler. The coupler may incorporate a sealing device to close the fluid compartment and/or may provide a separate attachment between the fluid compartment and the coupler in order to provide a rigid frame for the compartment. The coupler may also include interfaces for removable attachment to the fluid ports of the container and/or to a user delivery interface and/or to the fluid combining device. As illustrated, the fluid combining device is integrated into the coupler.

FIG. 25A is a front, perspective view in an open configuration and FIG. 25B is a perspective view in transition to a closed configuration of a fluid containing device according to aspects of the description.

The fluid containing device of FIGS. 25A-25B illustrate another embodiment in which the fluid compartments are within a single container that is subdivided into separate compartments. In this configuration, the divider between the separate compartments may provide a more substantial separation and/or may integrate and/or support the connection of the fluid combining device, and/or the fluid couplers (tubes) from one part of the system to another.

FIG. 26 is a front perspective view of an exemplary embodiment of a fluid containing device according to aspects of the description.

The exemplary embodiment of the fluid containing device is illustrative of features that may be incorporated or included in any of the fluid containing devices described herein, including, without limitation volume indicators, handles, openings, rigid support structures. Any fluid containing device described herein may incorporate any combination of indicators, handles, support structures. As illustrated, the container may comprise markings along an edge of the compartment to indicate an amount of fluid contained within the compartment. Also as illustrated, the compartment may comprise a support structure in the form of a rigid portion of the container, such as along a side or edge of the compartment to provide rigidity to the compartment, especially as it is inserted into an exterior holder. The container may also include handles, hooks or other support structures to assist in the handling of the container, storage of the container, and/or attachment of the container to another structure (such as the holder or drying or storage wrack).

FIGS. 27-31 illustrate exemplary fluid combining devices having fluid combining device comprises different selectors and/or indicators. As illustrated, the indicator may provide a visual indication to a user of the relative amounts of the respective fluid, such as from one fluid to the total and/or from one fluid to another fluid. The indicator may be is relation to the position of the selector itself, or may be separate therefrom. The indicator may be a graphical representation of the relative amounts of fluid, an alpha-numeric representation of the relative amounts of fluid, and/or a tactile representation of the relative amounts of fluid.

FIGS. 32-34 illustrate exemplary user delivery interfaces according to embodiments described herein having a fluid control mechanism and selector. As illustrated, the user delivery interface may comprise an interface that can deliver the mixture of fluid to a user. The user delivery interface may include an output port. The output port may comprise a valve for retaining a fluid in a closed configuration.

The exemplary embodiments illustrated in FIGS. 32-34 show an indicator at the user delivery interface. The indicator may be incorporated into a remote selector that may be configured to control the fluid combining device. The indicator and/or selectors illustrated in FIGS. 32-34 may therefore be configured and/or mate with the fluid control mechanisms of the fluid combining device.

The exemplary embodiments may also incorporate an indicator and a separate fluid control mechanism at the user delivery interface. The indicator and/or selectors illustrate din FIGS. 32-34 may therefore be configured as separate fluid control mechanism on the user deliver interface separate from the fluid combining device. In this configuration, the user delivery interface may comprise a user output. The user output may be a tube or other opening. The user output may also or alternatively comprise a valve, such as a bite valve in which a user has to engage in order to open the fluid flow path out of the fluid delivery device. The user delivery interface may also comprise a separate fluid control mechanism, such as another valve, or controlling a rate of flow and/or in opening and closing the fluid flow path from the user delivery interface. This separate fluid control mechanism may reduce the leakage of the system or accidental discharge of fluid if the bite valve is accidentally compressed. As illustrated, the fluid control mechanism may comprise a valve configured to stop or permit fluid flow through the user delivery interface. The system may also include a selector to change the position of the valve and/or an indicator to provide a visual indication to the user of the selection of whether the valve is open or not. Any visual indication may be used, such as the position of the selector, and/or graphical indication, and/or alphanumeric indication.

FIG. 35 is a perspective view of an exemplary holder in accordance with the description.

As illustrated the exemplary holder may comprise separate pockets for the different components of the system. For example, the holder may have a first location or pocket for the first container of the fluid containing device, a second location or pocket for a second container of the fluid containing device. The holder may include a location for the fluid combing device. The respective locations may be sized and configured to correspond to the respective component retained within that location and/or may be configured to retain the component within that location. The exemplary holder may also include attachment locations for a remote selector and/or for the user delivery interface. For example, the remote selector may couple to a first strap of the holder and the user delivery interface may couple to the same or different strap of the holder.

Exemplary embodiments of the fluid delivery system described herein may include a fluid containing device; a fluid combining device; and a user delivery interface.

The fluid containing device may include a first compartment and a second compartment, and the first compartment is in fluid communication with a first fluid input of the fluid combining device and the second compartment is in fluid communication with a second fluid input of the fluid combining device, and the fluid combining device comprises a fluid control mechanism to selectively restrict an amount of a first fluid flowing from the first fluid input, a second fluid flowing from the second fluid input, or both the first and second fluid flowing from the first and second fluid inputs.

The fluid delivery system may also include a selector configured to be engaged by a user to control a position of the fluid control mechanism of the fluid combining device and set the amount of restriction of the amount of the first fluid flowing from the first fluid input, the second fluid flowing from the second fluid input, or both the first and second fluid flowing from the first and second fluid inputs. The selector and the fluid control mechanism may be configured to dynamically adjust a relative amount of the first fluid within a total amount of fluid dispensed from the fluid delivery system. The selector may include an actuator to define predetermined positions of the selector that correspond to a select number of options of the relative amount of the first fluid within the total amount of fluid dispensed from the fluid delivery system for selection by the user.

The fluid delivery system may include an indicator to provide an indication to the user of the relative amount of the first fluid relative to either the total amount of fluid dispensed from the fluid delivery system or too the second fluid dispensed from the fluid delivery system.

The fluid delivery system may include an external holder to support and removably couple the fluid containing device and the fluid combining device.

The fluid control mechanism of the fluid combining device may selectively restrict the amount of the first fluid flowing from the first fluid input, the second fluid flowing from the second fluid input, or both the first and second fluid flowing from the first and second fluid inputs by changing a cross sectional area of the first fluid input, a second cross sectional area of the second fluid input, or both the first cross sectional area and the second cross sectional area. The fluid control mechanism may change the first cross sectional area of the first input by compressing a first fluid flow conduit of the first input and changes the second cross sectional are of the second input by compressing a second fluid flow conduit of the second input.

Exemplary embodiments described herein include a method of delivering fluid to a user. The method may include providing a fluid delivery device; filling a first fluid compartment of the fluid delivery device with a first fluid; filling a second fluid compartment of the fluid delivery device with a second fluid; positioning a selector of the fluid delivery device in association with a fluid control mechanism of a fluid combining device of the fluid delivery device to determine a ratio of the first fluid to the second fluid that is permitted to flow through the fluid combining device; and dispensing a fluid from the fluid delivery device at the ratio determined by the selector.

The method may also include repositioning the selector to a new location corresponding to a different ratio of the first fluid to the second fluid; and dispensing a new fluid from the fluid delivery device at the different ratio as determined by the new location of the selector.

The method may include any step to actuate any of the fluid combining device, fluid control mechanisms, fluid containing devices as described herein. For example, the method may include coupling inputs and outputs of the respective component parts to create fluid flow paths therebetween. The method may include dynamically adjust the fluid control mechanism as described herein, including engaging the respective selectors by screwing, sliding, translating, rotating, or otherwise positioning a selector to dictate a desired position of the fluid control mechanism and control the respective ratio of fluids out of the fluid delivery device.

Exemplary embodiments of the method may also include controlling and/or actuating any of the fluid control mechanisms described herein, such as, for example, a valve at the user delivery interface to turn on and/or off the fluid flow from the fluid delivery system.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a view of the device as shown in the present disclosure. Of course, if the device is inverted, above becomes below, and vice versa. Additionally, if oriented sideways, above and below may refer to sides of a device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, and algorithm steps described in connection with the disclosure herein may be implemented as various different types of materials and/or various different combinations of materials. To clearly illustrate this interchangeability, various illustrative components, blocks, modules, and steps have been described herein generally in terms of their functionality. The various materials and/or combinations of materials employed to implement the present disclosure depends upon the particular application and design constraints imposed on the overall system. Skilled artisans may implement the described functionality in varying ways for each particular application, but such implementation decisions should not be interpreted as causing a departure from the scope of the present disclosure.

The description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

As used herein, the terms “about,” “substantially,” or “approximately” for any numerical values, ranges, shapes, distances, relative relationships, etc. indicate a suitable dimensional tolerance that allows the part or collection of components to function for its intended purpose as described herein. Numerical ranges may also be provided herein. Unless otherwise indicated, each range is intended to include the endpoints, and any quantity within the provided range. Therefore, a range of 2-4, includes 2, 3, 4, and any subdivision between 2 and 4, such as 2.1, 2.01, and 2.001. The range also encompasses any combination of ranges, such that 2-4 includes 2-3 and 3-4.

When used in this specification and claims, the terms “comprises” and “comprising” and variations thereof mean that the specified features, steps or integers are included. The terms are not to be interpreted to exclude the presence of other features, steps or components.

Although several embodiments have been described in detail for purposes of illustration, various modifications may be made without departing from the scope and spirit of the present disclosure. Accordingly, the disclosure is not to be limited by the examples presented herein, but is envisioned as encompassing the scope described in the appended claims and the full range of equivalents of the appended claims.

What is claimed is:

1. Fluid delivery system, comprising:
a fluid containing device;
a fluid combining device; and
a user delivery interface

2. The fluid delivery system of claim 1, wherein the fluid containing device comprises a first compartment and a second compartment, and the first compartment is in fluid communication with a first fluid input of the fluid combining device and the second compartment is in fluid communication with a second fluid input of the fluid combining device, and the fluid combining device comprises a fluid control mechanism to selectively restrict an amount of a first fluid flowing from the first fluid input, a second fluid flowing from the second fluid input, or both the first and second fluid flowing from the first and second fluid inputs.

3. The fluid delivery system of claim 2, further comprising a selector configured to be engaged by a user to control a position of the fluid control mechanism of the fluid combining device and set the amount of restriction of the amount of the first fluid flowing from the first fluid input, the second fluid flowing from the second fluid input, or both the first and second fluid flowing from the first and second fluid inputs.

4. The fluid delivery system of claim 3, wherein the selector and the fluid control mechanism are configured to dynamically adjust a relative amount of the first fluid within a total amount of fluid dispensed from the fluid delivery system.

5. The fluid delivery system of claim 4, wherein the selector comprises an actuator to define predetermined positions of the selector that correspond to a select number of options of the relative amount of the first fluid within the total amount of fluid dispensed from the fluid delivery system for selection by the user.

6. The fluid delivery system of claim 6, further comprising an indicator to provide an indication to the user of the relative amount of the first fluid relative to either the total amount of fluid dispensed from the fluid delivery system or too the second fluid dispensed from the fluid delivery system.

7. The fluid delivery system of claim 6, further comprising an external holder to support and removably couple the fluid containing device and the fluid combining device.

8. The fluid delivery system of claim 7, wherein the fluid control mechanism of the fluid combining device selectively restricts the amount of the first fluid flowing from the first fluid input, the second fluid flowing from the second fluid input, or both the first and second fluid flowing from the first and second fluid inputs by changing a cross sectional area of the first fluid input, a second cross sectional area of the second fluid input, or both the first cross sectional area and the second cross sectional area.

9. The fluid delivery system of claim 8, wherein the fluid control mechanism changes the first cross sectional area of the first input by compressing a first fluid flow conduit of the first input and changes the second cross sectional are of the second input by compressing a second fluid flow conduit of the second input.

10. A method of delivering fluid to a user comprising:
providing a fluid delivery device;
filling a first fluid compartment of the fluid delivery device with a first fluid;
filling a second fluid compartment of the fluid delivery device with a second fluid;
positioning a selector of the fluid delivery device in association with a fluid control mechanism of a fluid combining device of the fluid delivery device to determine a ratio of the first fluid to the second fluid that is permitted to flow through the fluid combining device;
dispensing a fluid from the fluid delivery device at the ratio determined by the selector.

11. The method of claim 10 further comprising:
repositioning the selector to a new location corresponding to a different ratio of the first fluid to the second fluid; and
dispensing a new fluid from the fluid delivery device at the different ratio as determined by the new location of the selector.
